(19) United States
(12) Patent Application Publication
(10) Pub. No.: US 2026/0261380 A1
(43) Pub. Date: Sep. 3, 2026

(54) METHOD OF USER EQUIPMENT, METHOD OF ACCESS NETWORK NODE, USER EQUIPMENT, AND ACCESS NETWORK NODE

(71) Applicant: NEC Corporation, Minato-ku, Tokyo (JP)

(72) Inventor: Yinan QI, Guildford (GB)

(73) Assignee: NEC Corporation, Minato-ku, Tokyo (JP)

(21) Appl. No.: 18/872,896

(22) PCT Filed: Jul. 3, 2023
(86) PCT No.: PCT/JP2023/024593

§ 371 Date: Dec. 9, 2024

(30) Foreign Application Priority Data
Jul. 19, 2022 (GB) 2210582.9

(51) Int. Cl. H04L 5/00; H04W 72/232; H04W 72/40; H04W 72/51

(52) U.S. Cl. CPC H04L 5/0051; H04W 72/232; H04W 72/40; H04W 72/51

(57) ABSTRACT

A method performed by a user equipment (UE) is disclosed in which a positioning reference signal (PRS) is transmitted to, or received from, at least one further UE (3) using a communication resource of at least one resource pool which is configured based on configuration information. The configuration information includes information for at least one resource pool including the communication resource for at least one of transmission of a PRS to, and reception of a PRS from, the at least one further UE (3). The first information defines at least one pattern of a time domain resource for the at least one resource pool.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to the configuration of resources for sidelink positioning in new radio (NR) communication systems.

### BACKGROUND ART

Previous developments of the 3GPP standards include those referred to as the Long Term Evolution (LTE) of Evolved Packet Core (EPC) network and Evolved UMTS Terrestrial Radio Access Network (E-UTRAN), also commonly referred as ‘4G’. More recently, the term ‘5G’ and ‘new radio’ (NR) has been used to refer to an evolving communication technology that is expected to support a variety of applications and services such as MTC/IoT communications, vehicular communications and autonomous cars, high resolution video streaming, smart city services, and/or the like. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’ or ‘base station’) via which communication devices (user equipment or ‘UE’) connect to a core network and communicate to other communication devices or remote servers. Communication between the UEs and the base station is controlled using the so-called Radio Resource Control (RRC) protocol. For simplicity, the present application will use the term RAN node or base station to refer to any such access nodes.

In the current 5G architecture, the gNB structure may be split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), the Packet Data Convergence Protocol (PDCP) layer) and the, typically ‘lower’, DU layers (for example, but not necessarily or exclusively, radio link control (RLC) layer/media access control (MAC) layer/physical (PHY) layer) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term communication device, user device, or UE to refer to any communication device that is able to connect to the core network via one or more base stations. Although the present application may refer to mobile or user devices in the description, it will be appreciated that the technology described can be implemented on any communication devices (mobile and/or generally stationary) that can connect to a communications network for sending/receiving data, regardless of whether such communication devices are controlled by human input or software instructions stored in memory. For example, such a communication device may be operable by a human or may be a partially or fully automated (MTC/IoT) device.

The ability to accurately locate the position of a UE has long been an important and developing part of cellular communication technology. Originally driven by regulatory requirements for emergency calls, cellular positioning technology has been developed to provide significant improvements in accuracy, coverage extent (both indoors and outdoors), latency, reliability etc.

Positioning in 5G is anticipated to support many and varied positioning use cases, each coming with its own respective performance requirements. These use cases include, for example: enhanced indoor navigation (e.g., in shopping malls, hospitals, or underground facilities); tracking of unmanned (autonomous) vehicles; public safety applications (e.g., assisting first responders to reach emergencies more quickly, or monitoring the location of vulnerable people); smart factories; localised sensing; digital twins; augmented/virtual reality; etc.

Positioning methods supported in 5G include, amongst other things: RAT-dependent methods including Observed Time Difference Of Arrival (OTDOA) based positioning; Uplink Time Difference of Arrival (UTDOA) based positioning; Roundtrip time (RTT) based positioning; Angle of Arrival (AOA) based positioning; and RAT-independent methods including Global Navigation Satellite System (GNSS) based positioning; barometric sensor based positioning; and Bluetooth based positioning.

New reference signals and related measurements have been introduced in 5G to support enhanced (e.g., more accurate/precise) NR positioning related measurements (compared to LTE). These signals include newly defined dedicated positioning reference signals (PRS) for positioning in the downlink and sounding reference signals (SRS) for positioning in the uplink. For example, a UE can perform downlink reference signal time difference (DL RSTD) measurements for each base station's PRSs and report these to the location server for downlink positioning. Similarly, each base station can measure the uplink relative time of arrival (UL-RTOA) and report the measurements to the location server for uplink positioning. Moreover, channel state information reference signals (CSI-RS) and synchronisation signal blocks (SSBs) can also be used (e.g., as part of an enhanced cell ID (E-CID) positioning method).

More recent NR developments include: the provision of positioning for UEs in the RRC inactive state; on-demand transmission and reception of downlink PRS; enhancements for angle based methods; enhancements of information reporting from the UE, and the base station, for supporting mitigation of multipath/non-line of sight (NLOS) effects; enhancements of signalling and procedures for reducing positioning latency; and signalling and procedures to support global navigation satellite system (GNSS) positioning integrity.

Current communication technology also provides various ways in which UEs can communicate data between each other directly without using resources of a base station (although in some cases the UEs will require at least some control signalling from the base station). Such communications are often referred to as UE-to-UE direct communications, Device-to-Device (D2D) communications or sidelink communications. D2D communications were originally defined as part of Proximity Services (ProSe) services in Release 12 and Release 13 of the 3GPP specifications. As part of ProSe services, a new D2D interface was introduced. This D2D interface is referred to as ‘PC5’, or ‘Sidelink’ at the physical layer. Sidelink provides a direct link for communications between devices, with or without network coverage. As D2D technology has been developed, sidelink has been further enhanced for vehicular use cases, addressing high speed (up to 250 km/h along roads and up to 500 km/h along railways) and high density (thousands of nodes) scenarios as well.

Sidelink has several application areas/use cases, such as proximity services, public safety, IoT, including machine type communication and sensors, wearable devices, amongst others. The term Vehicle-to-Everything (V2X) covers a special application area of Sidelink/PC5 for the purpose of communications between vehicles using a direct link. V2X encompasses at least the following categories: Vehicle-to-Vehicle (V2V); Vehicle-to-Infrastructure (V2I); Vehicle-to-Pedestrian (V2P); Vehicle-to-Home (V2H); and enhanced Vehicle-to-Everything (eV2X).

As sidelink communication involves direct communication between UEs it supports a range of use cases in which a UE is not necessarily within coverage of a base station. These use cases include in-coverage use cases in which a given pair of UEs involved in sidelink communication are both in coverage of the base station, partial-coverage use cases in which one of the UEs involved in the sidelink communication is in coverage of the base station while another of the UEs involved in the sidelink communication is not in coverage of the base station, and out-of-coverage use cases in which neither of a given pair of UEs involved in sidelink communication are in coverage of the base station. Of course, a given UE may move between in-coverage, partial coverage, and out-of-coverage scenarios.

Many of these sidelink use cases require positioning and so there is a general need to develop techniques and enhancements for supporting sidelink positioning. In order to develop such techniques and enhancements for supporting sidelink positioning due consideration needs to be given to the specific scenarios and/or requirements that sidelink positioning potentially needs to support. The coverage scenarios for consideration include, for example, the various coverage scenarios introduced above (in-coverage, partial-coverage, and out-of-coverage). The various use cases for consideration include, for example, such as (e)V2X use cases (e.g., as discussed in 3GPP TR 38.845), public safety use cases (e.g., as also discussed in 3GPP TR 38.845), commercial use cases (e.g., as discussed in 3GPP TS 22.261), and/or industrial internet of things (IIOT) use cases (e.g., as discussed in 3GPP TS 22.104). The requirements for consideration include, for example, those identified in in TR 38.845, TS 22.261, and/or TS22.104. Moreover, consideration needs to be given to the spectrum that may be used for sidelink use cases including both dedicated intelligent transportation systems (ITS) spectrum the spectrum licensed to mobile network operators (including FR2).

In order to support positioning involving sidelink, it has been proposed to introduce sidelink positioning reference signals (SL-PRS or S-PRS)—i.e., positioning reference signals transmitted/received in the sidelink and used for positioning purpose. There is, therefore, a need for efficient methods for configuring such SL-PRS signals.

However, the UEs that may be involved in sidelink communication may be low-end UEs having limited communication capabilities. This puts constraints on the time and frequency resources available for sidelink communication and, by extension, the time and frequency resources available for SL-PRS. For example, while a base station can typically support the wide bandwidths available in 5G, this may not be the case for all UEs, in particular low-end UEs. Moreover, supporting a very large bandwidth also implies higher power consumption at the UE, both from the radio frequency (RF) and baseband signal processing perspectives. This presents a challenge to the development of efficient procedures for configuring time and frequency resources for the transmission and reception of SL-PRS.

### CITATION LIST

### Patent Literature

PTL 1:WO2021/066592A1
PTL 2:WO2021/188220A1
PTL 3:WO20221/086114A1

### Non Patent Literature

NPL 1: 3GPP TR 38.845
NPL 2: 3GPP TS 22.261
NPL 3: 3GPP TS 22.104
NPL 4: 3GPP TR 38.845

### SUMMARY OF INVENTION

### Technical Problem

The disclosure aims to provide apparatus and related methods aimed at contributing, at least partially, to meeting one or more of the above needs.

### Solution to Problem

In one aspect there is provided a method performed by a user equipment (UE), the method comprising:
transmitting a positioning reference signal (PRS) to, or receiving a PRS from, a further UE using a resource of at least one resource pool which is configured based on configuration information which defines at least one pattern of a time domain resource for the at least one resource pool for UE-to-UE communication, wherein
the resource is determined by at least one multiplexing mode which determines at least one PRS resource multiplexed with/without at least one resource for at least one of physical sidelink control channel (PSCCH) or physical sidelink shared channel (PSSCH).

In one aspect there is provided a user equipment (UE) comprising:
means for transmitting a positioning reference signal (PRS) to, or receiving a PRS from, a further UE using a resource of at least one resource pool which is configured based on configuration information which defines at least one pattern of a time domain resource for the at least one resource pool for UE-to-UE communication, wherein
the resource is determined by at least one multiplexing mode which determines at least one PRS resource multiplexed with/without at least one resource for at least one of physical sidelink control channel (PSCCH) or physical sidelink shared channel (PSSCH).

In one aspect there is provided a method performed by an access network node, the method comprising:
transmitting, to a user equipment (UE), configuration information which defines at least one pattern of a time domain resource for at least one resource pool including a resource for at least one of transmission of a positioning reference signal (PRS) by the UE to, or reception of a PRS by the UE from, a further UE, wherein
the resource is determined by at least one multiplexing mode which determines at least one PRS resource multiplexed with/without at least one resource for at least one of physical sidelink control channel (PSCCH) or physical sidelink shared channel (PSSCH).

In one aspect there is provided an access network node comprising:
means for transmitting, to a user equipment (UE), configuration information which defines at least one pattern of a time domain resource for at least one resource pool including a resource for at least one of transmission of a positioning reference signal (PRS) by the UE to, or reception of a PRS by the UE from, a further UE, wherein
the resource is determined by at least one multiplexing mode which determines at least one PRS resource multiplexed with/without at least one resource for at least one of physical sidelink control channel (PSCCH) or physical sidelink shared channel (PSSCH).

### Advantageous Effects of Invention

According to the present disclosure, it is possible to provide a method of a user equipment, a method of an access network node, the user equipment, and the access network node.

### BRIEF DESCRIPTION OF DRAWINGS

Embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 illustrates a typical configuration of sidelink resources that may be used in the telecommunication system of FIG. 1;

FIG. 4A illustrate a different type of slot format that may be used in the telecommunication system 1;

FIG. 4B illustrate a different type of slot format that may be used in the telecommunication system 1;

FIG. 5 is a simplified schematic block diagram illustrating the main components of a UE for the telecommunication system of FIG. 1;

FIG. 6 is a simplified schematic block diagram illustrating the main components of a base station for the telecommunication system of FIG. 1;

FIG. 7 is a simplified sequence diagram illustrating a number of different ways in which a UE 3 may be configured the telecommunication system of FIG. 1;

FIG. 8A is a simplified illustration of a different possible timing configuration for a SL-PRS resource pool that may be used in the telecommunication system of FIG. 1;

FIG. 8B is a simplified illustration of a different possible timing configuration for a SL-PRS resource pool that may be used in the telecommunication system of FIG. 1;

FIG. 9A is a simplified illustration of a different possible timing configuration for a measurement resource pool that may be used in the telecommunication system of FIG. 1;

FIG. 9B is a simplified illustration of a different possible timing configuration for a measurement resource pool that may be used in the telecommunication system of FIG. 1;

FIG. 10 is a simplified illustration of a possible timing configuration for another resource pool that may be used in the telecommunication system of FIG. 1;

FIG. 11 illustrates a possible timing configuration for a shared resource pool that may be used in the telecommunication system of FIG. 1;

FIG. 12A is a simplified illustration of a possible timing configuration for a different possible technique involving a shared resource pool that may be used in the telecommunication system of FIG. 1;

FIG. 12B is a simplified illustration of a possible timing configuration for a different possible technique involving a shared resource pool that may be used in the telecommunication system of FIG. 1;

FIG. 13A is a simplified illustration of a different possible frequency domain configuration for resource pools that may be used in the telecommunication system of FIG. 1;

FIG. 13B is a simplified illustration of a different possible frequency domain configuration for resource pools that may be used in the telecommunication system of FIG. 1;

FIG. 13C is a simplified illustration of a different possible frequency domain configuration for resource pools that may be used in the telecommunication system of FIG. 1;

FIG. 14 is a simplified illustration of a first time domain resource pool configuration scenario that may occur in the telecommunication system of FIG. 1;

FIG. 15 is a simplified illustration of a second time domain resource pool configuration scenario that may occur in the telecommunication system of FIG. 1;

FIG. 16 is a simplified illustration of a third time domain resource pool configuration scenario that may occur in the telecommunication system of FIG. 1;

FIG. 17 illustrates another time domain time domain configuration technique that may be used in the telecommunication system of FIG. 1;

FIG. 18A is a simplified illustration of a respective variation of a multiplexing mode that may be used in the telecommunication system of FIG. 1;

FIG. 18B is a simplified illustration of a respective variation of a multiplexing mode that may be used in the telecommunication system of FIG. 1;

FIG. 19A is a simplified illustration of another respective multiplexing mode that may be used in the telecommunication system of FIG. 1;

FIG. 19B is a simplified illustration of another respective multiplexing mode that may be used in the telecommunication system of FIG. 1; and

FIG. 20 is a simplified illustration of another possible multiplexing mode that may be used in the telecommunication system of FIG. 1.

### DESCRIPTION OF EMBODIMENTS

### <Overview>

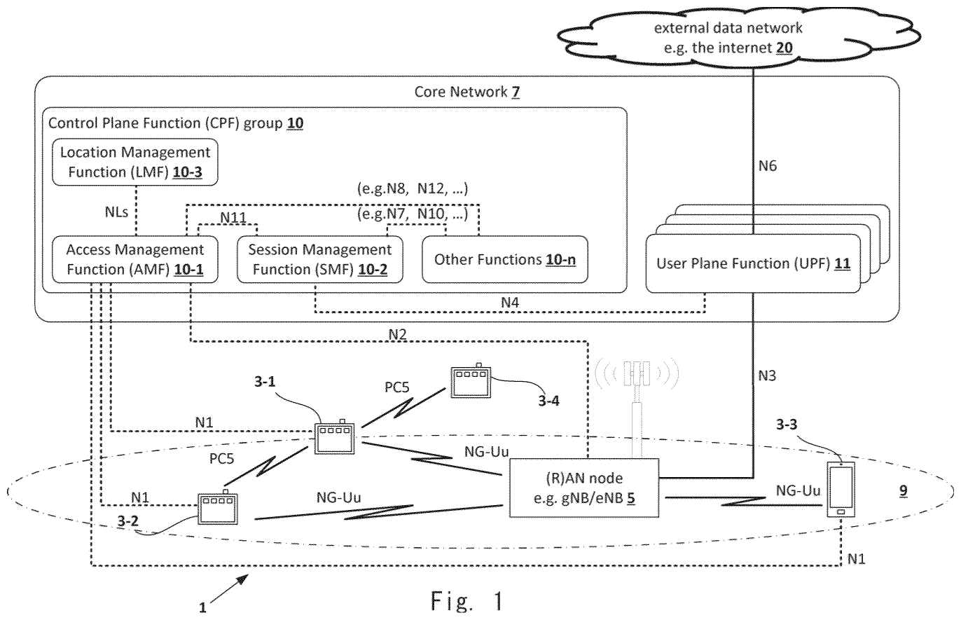

An exemplary telecommunication system will now be described in overview, by way of example only, with reference to FIGS. 1 to 4.

FIG. 1 schematically illustrates a mobile (‘cellular’ or ‘wireless’) telecommunication system 1 to which embodiments of the present disclosure are applicable.

In the network 1 user equipment (UEs) 3-1, 3-2, 3-3, 3-4 (e.g., mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g., a 5G core network or evolved packet core network (EPC)).

As those skilled in the art will appreciate, whilst four UEs 3 and one base station 5 are shown in FIG. 1 for illustration purposes, the system, when implemented, will typically include other base stations and UEs.

Each base station 5 controls one or more associated cells either directly, or indirectly via one or more other nodes (such as home base stations, relays, remote radio heads, distributed units, transmission reception points (TRPs) and/or the like). It will be appreciated that the base stations 5 may be configured to support both 4G and 5G, and/or any other 3GPP or non-3GPP communication protocols.

The UEs 3 and their serving base station 5 are connected via an appropriate air interface (for example the so-called ‘NG-Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2, a one or more Location Management Function (LMFs) 10-3, and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One of more UPFs 11 are connected to an external data network (e.g., an IP network such as the internet) via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 is connected to the AMF 10-1 via an N11 reference point. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The LMF 10-3 manages the support of different location services for UEs 3 whose location is unknown and needs to be located (‘target UEs’), including positioning of the UEs 3 and delivery of assistance data to the UEs 3. The LMF 10-3 may interact with a serving base station 5 for a target UE 3 in order to obtain position measurements for that UE 3, including uplink measurements made by the base station (e.g., of SRS) and downlink measurements made by the UE 3 (e.g., of PRS/SL-PRS) and provided to the base station 5. The LMF 10-3 may interact with a target UE 3 in order to deliver assistance data if requested for a particular location service, or to obtain a location estimate if requested.

For positioning of a target UE 3, the LMF 10-3 decides on the position methods to be used, based on factors that may include, for example, a location services (LCS) client type, a required quality of service (QoS), UE positioning capabilities, and/or base station positioning capabilities. The LMF 10-3 can invoke these positioning methods in the UE 3 and/or serving base station. The positioning methods may yield a location estimate for UE-based position methods and/or positioning measurements for UE-assisted and network-based position methods. The LMF 10-3 may combine the received results and determine a single location estimate for the target UE 3. Additional information like accuracy of the location estimate and velocity may also be determined.

The LMF 10-3 is connected to the AMF 10-1 via an NLs reference point. The LMF 10-3 is configured to receive measurement results (e.g., for PRS) and assistance information from the base station 5 and/or UEs 3, via the AMF 10-1 over the NLs interface, and to compute the position of the UEs 3 based on the measurement results. The communication of positioning information between the base station 5 and the LMF 10-3 makes use of an appropriate protocol (such as the NR Positioning Protocol A (NRPPa)). The LMF 10-3 is also configured for configuring the UEs 3 using an appropriate protocol (e.g., the LTE positioning protocol (LPP)) via AMF 10-1.

The base station 5 is configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on the physical uplink shared channel PUSCH. The PBCH provides UEs 3 with the Master Information Block, MIB. It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), positioning reference signal (PRS) as described earlier, and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, a physical uplink shared channel (PUSCH), a physical uplink control channel (PUCCH), and/or a physical random access channel (PRACH). The UL physical signals may include, for example, demodulation reference signals (DMRS) for a UL control/data signal, and/or sounding reference signals (SRS) used for UL channel measurement and/or measurements for UL positioning.

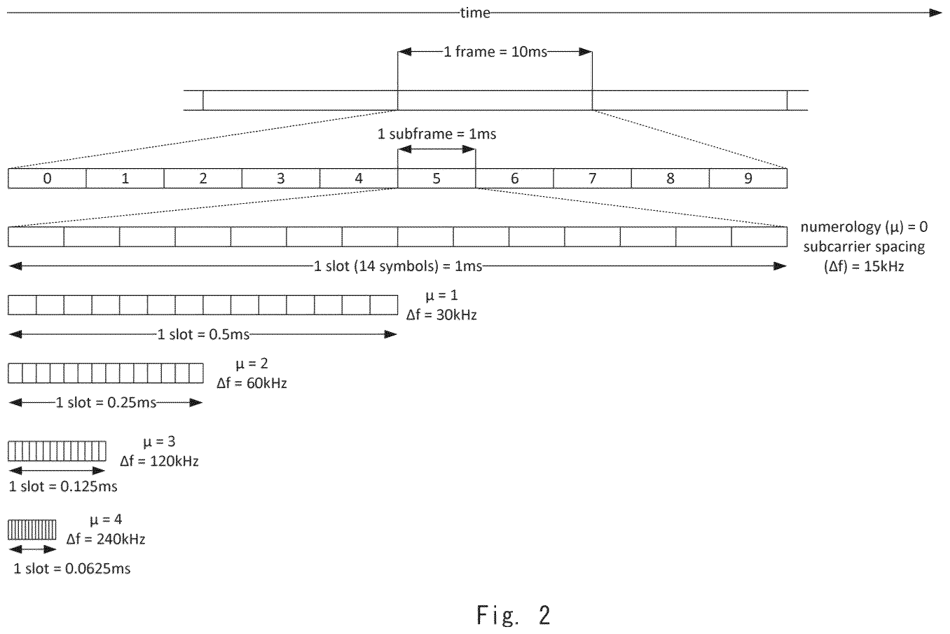

Referring to FIG. 2, which illustrates the typical frame structure that may be used in the telecommunication system 1, the base station 5 and UEs 3 of the telecommunication system 1 communicate with one another using resources that are organised, in the time domain, into frames of length 10 ms. Each frame comprises ten equally sized subframes of Tms length. Each subframe is divided into one or more slots comprising 14 Orthogonal frequency-division multiplexing (OFDM) symbols of equal length.

As seen in FIG. 2, the telecommunication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e., SCS=15×2μ kHz). The relationship between the parameter, μ, and SCS (Δf) is as shown in Table 1.

TABLE 1
5G Numerology

| | | Number of slots per | |
|---|---|---|---|
| μ | Δf = 2^{μ} · 15[kHz] | subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

In the communication system 1 the cell bandwidth can be divided into multiple bandwidth parts (BWPs) that each start at a respective starting resource block (RB) and respectively comprises of a set of contiguous RBs with a given numerology (sub-carrier spacing, ‘SCS’, and cyclic prefix, ‘CP’) on a given carrier. By defining a small BWP for a UE 3, the computational complexity and power consumption of that UE 3 can be reduced. As each BWP can have a different bandwidth and numerology, BWPs enable flexible and efficient use of resources by dividing the carrier bandwidth for multiplexing transmissions with different configurations and requirements.

The UEs 3 and base station 5 of the communication system 1 are thus configured for operation using BWPs. For each serving cell of a UE 3, the base station 5 can configure at least one downlink (DL) BWP (e.g., an initial DL BWP). The base station 5 may configure the UE 3 with up to a maximum (typically four) further DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g., an initial UL BWP). The base station 5 may configure the UE 3 with up to a maximum (typically four) further UL BWPs with only one UL BWP being active at a given time. The UE 3 does not transmit PUSCH or PUCCH outside an active bandwidth part. For an active cell, the UE 3 does not transmit SRS outside an active bandwidth part.

A BWP identifier or index (BWP-ID) is used to refer to BWPs (in UL and DL independently). Various radio resource control (RRC) configuration procedures can thus use the BWP-ID to associate themselves with a particular BWP.

The UEs 3 and base station 5 are configured to support positioning in the telecommunication system 1, for example by transmitting appropriate reference signals (e.g., SRS in the uplink and PRS in the downlink respectively), and by performing appropriate measurements on those reference signals (e.g., PRS in the downlink and SRS in the uplink respectively) and reporting the results to the LMF 10-3 for position determination. A UE 3 may, for example, perform measurements of the times at which reference signals (e.g., PRS) are received from different base stations 5 to determine downlink reference signal time difference (DL RSTD) for the purposes of DL time difference of arrival (DL-TDOA) based positioning. A UE 3 may, for example, perform measurements of downlink reference signal receive power (DL RSRP) per beam/base station for use in determining the downlink angle of departure (DL AoD) based on UE beam location for each base station. The LMF 10-3 can then use the AoDs to estimate the UE position. A base station 5 may, for example, perform measurements of the times at which reference signals (e.g., SRS) are received at the base station 5 to determine uplink relative time of arrival (UL RTOA) for the purposes of UL time difference of arrival (UL-TDOA) based positioning. A base station 5 may, for example, perform measurements of an angle of arrival of received reference signals based on a beam the UE is located in for the purposes of UL angle of arrival (UL-AOA) based positioning. The UE 3 and base station 5 may also perform receiver transmitter (Rx-Tx) time difference measurements for signals in each cell. Measurement reports including the results of these measurements from the UE 3 and base station 5 can then be used by the LMF 10-3 to derive corresponding round trip times (RTTs) for the purposes of multi-cell RTT based positioning.

In the telecommunication system 1, at least some of the UEs 3-1, 3-2, and 3-4 are capable of performing direct (UE-to-UE)—or ‘sidelink’—communication between one another, via a direct UE-to-UE interface (e.g., the ‘sidelink’ or ‘PC5’ interface) when in range. This direct communication may be: in-coverage sidelink communication involving a pair of UEs 3-1, 3-2 that are both in coverage of the base station 5 (e.g., as illustrated between UEs 3-2 and 3-1); partial-coverage sidelink communication involving a UE 3-1 that is in coverage of the base station 5 and a UE 3-4 that is not in coverage of the base station 5 (e.g., as illustrated between UEs 3-4 and 3-1); or out-of-coverage sidelink communication involving a pair of UEs 3-4 that are both outside the coverage of the base station 5.

The sidelink capable the UEs 3-1, 3-2, 3-4 are configured for communication via a number of dedicated sidelink physical channels and transmission/reception of a number of SL physical signals. The sidelink physical channels include the Physical Sidelink Broadcast Channel (PSBCH), the Physical Sidelink Feedback Channel (PSFCH), the Physical Sidelink Shared Channel (PSSCH), and the Physical Sidelink Control Channel (PSCCH).

The PSBCH carries the sidelink broadcast transport channel (SL-BCH) which is used for periodic transmission (e.g., every 160 ms) of a Master Information Block (MIB) for sidelink. The MIB carries system information for UE-to-UE communication. The information carried by the PSBCH is transmitted with a Sidelink Primary Synchronization Signal/Sidelink Secondary Synchronization Signal (S-PSS/SSS) as part of a sidelink-synchronization signal block (S-SSB).

The PSFCH is used for transmission of hybrid automatic repeat request (HARQ) feedback from a receiver UE 3-1, 3-2, 3-4 to a transmitter UE 3-1, 3-2, 3-4 on the SL for a unicast or groupcast communication.

The PSSCH contains transport blocks (i.e., user data traffic) of the sidelink shared transport channel (SL-SCH) and is associated with a PSCCH. The PSCCH is transmitted on the same slot as the PSSCH transmission and contains, amongst other things, sidelink control information (SCI) for the PSSCH.

SCI is sent in two stages. The 1st stage is carried by a PSCCH (as indicated above) and the 2nd stage is carried by a corresponding PSSCH, which is associated with the PSCCH. The first-stage SCI contains information to enable sensing operations, information about the resource allocation of the PSSCH, and, when needed, an indication that the UE can receive conflict information in inter-UE coordination. The 1st stage SCI typically includes, for example: a priority; a frequency resource assignment; a time resource assignment; a resource reservation period; a demodulation reference signal (DMRS) pattern; a 2nd-stage SCI format; a modulation and coding scheme; one or more reserved bits; a beta offset indicator; and/or a number of a DMRS port.

The second-stage SCI can carry information needed to identify and decode the associated SL-SCH, as well as control for HARQ procedures, triggers for channel state information (CSI) feedback, inter-UE coordination requests and information, etc. The 2nd stage SCI typically includes, for example: a HARQ process ID; a new data indicator; a redundancy version; a source ID; a destination ID; and/or a CSI request.

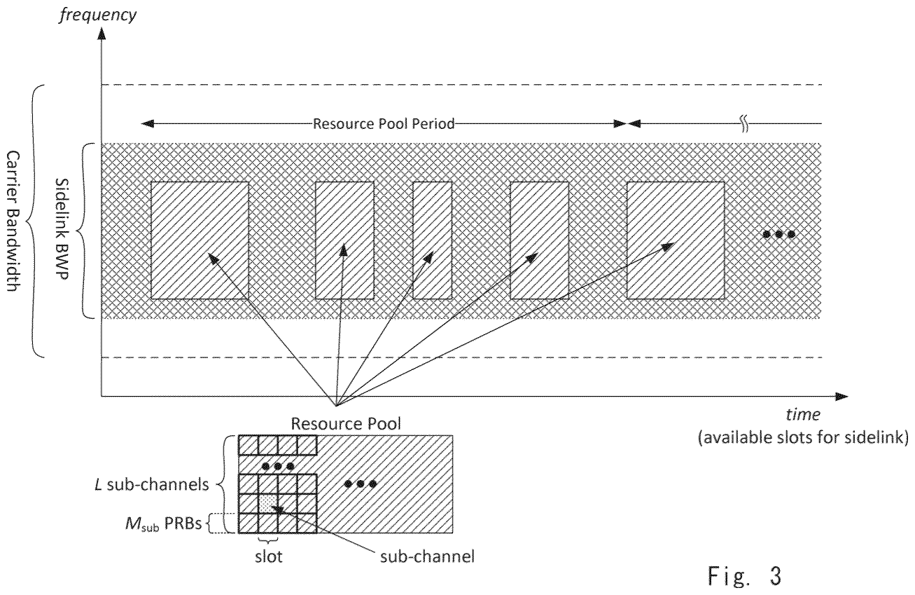

Referring to FIG. 3, which illustrates a typical configuration of sidelink resources that may be used in the telecommunication system of FIG. 1, the base station 5 is able to configure at least one respective dedicated sidelink BWP (SL-BWP) for each of the sidelink capable UEs 3-1, 3-2, 3-4. Each SL BWP occupies a contiguous portion of the bandwidth within the component carrier on which the cell 9 is provided. Sidelink transmissions and receptions for a given UE 3-1, 3-2, 3-4 will be contained within the SL BWP configured for that UE 3-1, 3-2, 3-4 and will employ the same numerology. Thus, all physical channels, reference signals and synchronization signals in the sidelink are transmitted within the corresponding SL BWP. This also means that, in the sidelink, a UE 3-1, 3-2, 3-4 is not expected to receive or to transmit using more than one numerology. The SL BWP is divided into common RBs where a common RB consists of 12 consecutive subcarriers with the same SCS, where the SCS is given by the numerology of the SL BWP.

The communication resources available for sidelink comprise time resources (e.g., sots) and frequency resources (e.g., common RBs) within a SL BWP. A subset of these available sidelink resources may be preconfigured/configured to be used by one or more UEs 3-1, 3-2, 3-4 for their sidelink communication (transmissions/receptions). This subset of available resources may be referred to as a ‘resource pool’.

A given UE 3-1, 3-2, 3-4 can be preconfigured/configured with a plurality of resource pools including one or more resource pools for transmission (TX resource pools) and with one or more resource pools for reception (RX resource pools). Accordingly, a UE 3-1, 3-2, 3-4 is able to receive data on resource pools used for SL transmissions by other UEs 3-1, 3-2, 3-4, while the UE 3-1, 3-2, 3-4 can still transmit on the sidelink using its transmit resource pools. A resource pool can be used for all transmission types (for example, unicast, groupcast, and/or broadcast).

The common resource blocks within a resource pool may also be referred to as physical resource blocks (PRBs). As seen in FIG. 3, the illustrated resource pool consists of contiguous PRBs and contiguous, or non-contiguous, slots that have been preconfigured/configured for sidelink communication. The resource pool is defined to be within the SL BWP and so a single numerology is used within the resource pool. If a UE 3-1, 3-2, 3-4 has been configured with an active UL BWP, then the SL BWP will also use the same numerology as the UL BWP if they both BWPs are on the same carrier.

The resource pool is divided, in the frequency domain, into a preconfigured/configured number (‘L’) of contiguous sub-channels (representing the smallest frequency unit for sidelink data transmission/reception), where each sub-channel comprises a group of consecutive PRBs in a slot. The size of the sub-channel (in units of PRBs) is given by ‘Msub’ and may be preconfigured/configured to be any suitable size (for example, 10, 12, 15, 20, 25, 50, 75, or 100 PRBs). Each sidelink transmission may use one or multiple sub-channels.

In the time domain, the slots that are part of a resource pool are preconfigured/configured and occur with a pre-set periodicity corresponding to a resource pool period (the resource pool period is typically, for example, 10240 ms). The slots that form the resource pool may be preconfigured/configured, for example by means of a bitmap which may be any suitable length (for example 10, 11, 12, . . . , 160 bits).

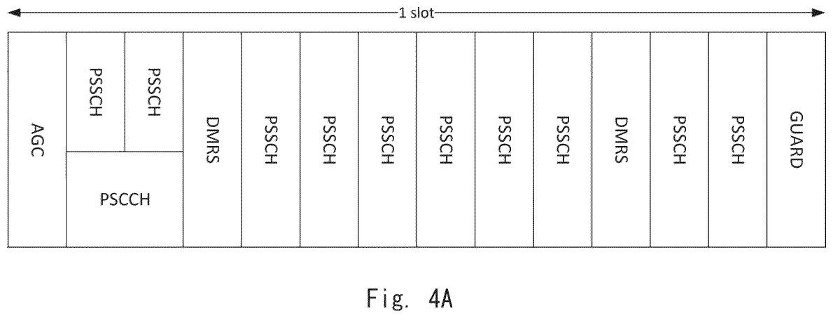

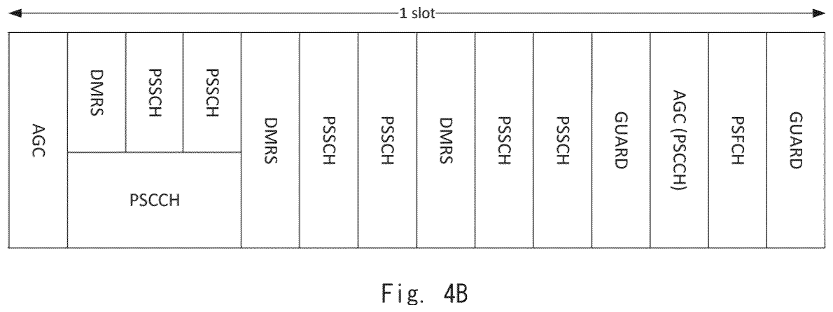

FIGS. 4A and 4B respectively illustrate a different type of slot format that may be used in the telecommunication system 1. As seen in FIG. 4, each slot can include PSSCH, PSCCH, PSFCH, automatic gain control (AGC) and guard symbols. The AGC and guard symbols are sent as specific symbols. AGC symbols may be used for level control in a sidelink receiver whereas guard symbols may be used as guard periods for switching between sidelink reception and transmission. Guard symbols are placed as immediate symbols after PSSCH, PSFCH, or S-SSB.

The PSSCH is transmitted in consecutive symbols of a slot. The start symbol and the number of symbols to transmit the PSSCH are configured by a higher layer, (e.g., media access control (MAC)). A PSSCH cannot be transmitted in the same symbols that are configured for the transmission of PSFCH or the last symbol of the slot, which is configured as a place holder for a guard symbol.

Beneficially, the sidelink capable UEs 3-1, 3-2, 3-4 and base station 5 of the communication system 1 are configured for supporting sidelink based positioning. Specifically, the UEs 3-1, 3-2, 3-4 are configured for transmitting, receiving, measuring, and reporting, via the base station 5, sidelink positioning reference signals (SL-PRS). In particular, the sidelink capable UEs 3-1, 3-2, 3-4 can be configured by the base station 5 and/or can be preconfigured with one or more resource pools from which resources for transmission and/or reception of SL-PRS can be allocated.

A number of different techniques for supporting sidelink based positioning are described later in this document, by way of example only. In some of the exemplary techniques one or more dedicated resource pools may be (pre)configurable at the UE 3-1, 3-2, 3-4 for the transmission/reception of SL-PRS and/or for transmission/reception of measurement reports carrying the results of measurements of the SL-PRS. In this case a given dedicated SL-PRS resource pool may be (pre)configured as a transmitter (Tx) resource pool for transmission of SL-PRS or as a receiver (Rx) resource pool for reception of SL-PRS. Similarly, a given dedicated measurement report resource pool may be (pre)configured as a transmitter (Tx) resource pool for transmission of measurement reports or as a receiver (Rx) resource pool for reception of measurement reports.

In some of the exemplary techniques the resources of one or more pre(configured) shared sidelink resource pools may be used for the transmission/reception of SL-PRS and conventional sidelink (data) communication.

Where dedicated resource pools are (pre)configurable, one or more separate dedicated resource pools may respectively be (pre)configured for transmission/reception of SL-PRS and for transmission/reception of measurement reports. In this case, as described in more detail later, the SL-PRS resource pool will typically include SL-PRS transmissions without any transmissions of measurement reports or other data. Nevertheless, as described in more detail later, a PSCCH carrying first stage SCI and a PSSCH carrying second stage SCI could potentially be included with the SL-PRS within one time slot.

Beneficially, in the exemplary techniques in which a separate dedicated resource pool is (pre)configured for measurement reporting the resource pool may, beneficially, be configured to use time resources relative to those (pre)configured for the SL-PRS resource pool in order to meet one or more predefined or configured maximum latency requirements.

In addition, or in the alternative, in the case where dedicated resource pools are (pre)configurable, one or more dedicated resource pools may be (pre)configurable in which both transmission/reception of SL-PRS and for transmission/reception of measurement reports is allowed in the same one or more dedicated resource pools.

Where the resources of one or more pre(configured) shared sidelink resource pools may be used, the one or more pre(configured) shared sidelink resource pools may be one or more conventional sidelink resource pools that can be shared between a plurality of different UEs 3, but in which SL-PRS can be multiplexed with sidelink data (including data in the form of measurement reports) communicated, for example, via the PSSCH.

It will be appreciated, for completeness, that the respective techniques involving the use of dedicated resource pools and shared resource pools to support sidelink positioning are not mutually exclusive. For example, a dedicated resource pool may be (pre)configurable for SL-PRS only and a shared resource pool may be used for the transmission/reception of measurement reports (and other sidelink data). Similarly, a dedicated resource pool may be (pre)configurable for measurement results only (without other data) and a shared resource pool may be used for the transmission/reception of other sidelink data multiplexed with SL-PRS.

Beneficially, as described in more detail later, to support sidelink positioning, the sidelink capable UEs 3-1, 3-2, 3-4 of the communication system 1 (and the base station 5 where appropriate) are configured for implementing one or more appropriate techniques for frequency domain configuration of resource pools for SL-PRS/measurement report.

Beneficially, as described in more detail later, to support sidelink positioning, the sidelink capable UEs 3-1, 3-2, 3-4 of the communication system 1 (and the base station 5 where appropriate) are configured for implementing one or more appropriate techniques for time domain configuration of resource pools for SL-PRS/measurement report.

Beneficially, as described in more detail later, to support sidelink positioning, the sidelink capable UEs 3-1, 3-2, 3-4 of the communication system 1 (and the base station 5 where appropriate) are configured for implementing one or more different multiplexing modes for the multiplexing of SL-PRS.

### <User Equipment>

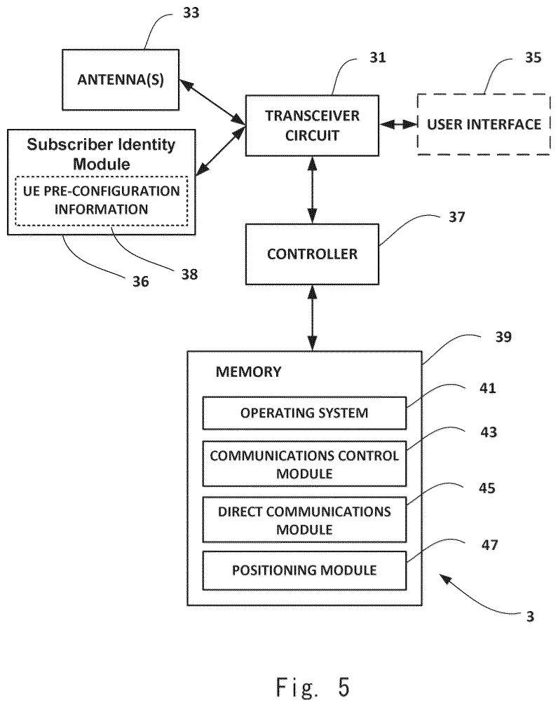

FIG. 5 is a schematic block diagram illustrating the main components of a UE 3 for the communication system 1 shown in FIG. 1. In this example the UE 3 is a UE that is capable of performing sidelink communication.

As shown, the UE 3 has a transceiver circuit 31 that is operable to transmit signals to and to receive signals from a base station 5 via one or more antennas 33. The UE 3 includes a subscriber identity module (SIM) 36 which may be implemented in any suitable manner, for example physically (e.g., as a universal integrated circuit card (UICC) or the like) or virtually (e.g., as an embedded SIM (eSIM) or the like). The UE 3 also has a controller 37 to control the operation of the UE 3. The controller 37 is associated with a memory 39 and is coupled to the transceiver circuit 31.

Although not necessarily required for its operation, the UE 3 might, of course, have all the usual functionality of a conventional UE 3 (e.g., a user interface 35, such as a touch screen/keypad/microphone/speaker and/or the like for, allowing direct control by and interaction with a user) and this may be provided by any one or any combination of hardware, software, and firmware, as appropriate. Software may be pre-installed in the memory 39 and/or may be downloaded via the telecommunications network or from a removable data storage device (RMD), for example.

In addition to subscriber information and security information (such as the UE's international mobile subscriber identity (IMSI) and encryption keys), the SIM 36 can store UE pre-configuration information 38 for preconfiguring the UE 3. This pre-configuration information may include, for example, pre-configuration information for configuring one or more resource pools at the UE 3 (e.g., dedicated SL-PRS or measurement report resource pools) that can be applied by the UE 3 autonomously (without network involvement).

The controller 37 is configured to control overall operation of the UE 3 by, in this example, program instructions or software instructions stored within memory 39. As shown, these software instructions include, among other things, an operating system 41, a communications control module 43, a direct communications module 45, and a positioning module 47.

The communications control module 43 is operable to control the overall communication between the UE 3 and its one or more serving base stations 5 (and other communication devices connected to the base station 5, such as further UEs and/or core network nodes). The communications control module 43 handles, for example, the generation/sending/receiving of signalling messages and sidelink/uplink/downlink data packets between the UE 3 and other nodes and devices. The signalling may comprise control signalling (e.g., via system information or RRC) related to UE positioning. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an IP sub-module, an RRC sub-module, etc. The communications control module 43 is also responsible for the overall handling uplink communications via associated uplink channels (e.g., via a physical uplink control channel (PUCCH) and/or a physical uplink shared channel (PUSCH)) including both dynamic and semi-static signalling (e.g., SRS). The communications control module 43 is also configured for the overall handling of receipt of downlink communications via associated downlink channels (e.g., via a physical downlink control channel (PDCCH) and/or a physical downlink shared channel (PDSCH)) including both dynamic and semi-static signalling (e.g., PRS). The communications control module 43 is responsible for determining the resources to be used by the UE 3, to determine how frequency resources and/or slots/symbols are configured (e.g., for UL communication, DL communication, or the like), and to determine which one or more bandwidth parts are configured for the UE 3.

The direct communications module 45 operates under the overall control of the communications control module 43 and is responsible for direct UE-to-UE (i.e., sidelink) communication. The direct UE-to-UE communication includes, for example, the transmission/reception of SL-PRS and the transmission/reception of SL-PRS associated measurement reports. The direct UE-to-UE communication may be based, for example, on control information/configuration information received (e.g., via the communications control module 43) from the base station 5 (e.g., in downlink control information (DCI) provided in the PDCCH, RRC or MAC signalling), or from other UEs 3 (e.g., in sidelink control information (SCI) provided in the PSCCH or PSSCH, or in RRC signalling sent/transferred via the PC5 interface (e.g., using PC5-RRC signalling)). It will nevertheless be appreciated that the direct UE-to-UE communication may be based fully or partially on configuration information obtained from the SIM 36 (e.g., stored as UE pre-configuration information 38). The direct communications module 45 is also responsible for determining, based on the control information/configuration information, the resource pools (shared and/or dedicated) and associated resources within those pools to be used by the UE 3 for direct UE-to-UE communication including the transmission/reception of SL-PRS, and/or the transmission/reception of SL-PRS associated measurement reports.

The positioning module 47 is responsible for positioning related procedures including, for example performing measurements and generating associated measurement reports (e.g., time difference of arrival and/or the like) in respect of sidelink positioning reference signals SL-PRS from another UE, and in respect of PRS from the serving base station and/or other base stations.

The positioning module 47 may communicate (via the direct communications module 45) with other UEs 3 over an appropriate UE-to-UE interface such as Sidelink/PC5. The positioning module 47 may also communicate (via the communications control module 43) with the base station 5 and/or a positioning function entity in the core network 7 such as the LMF 10-3. Such communication with the positioning function entity may, for example, be used for assisting the UE 3 to determine the UE's location (or the location of another device) and/or to provide the location to the UE 3 (if determined by the positioning function entity itself).

### <Base Station>

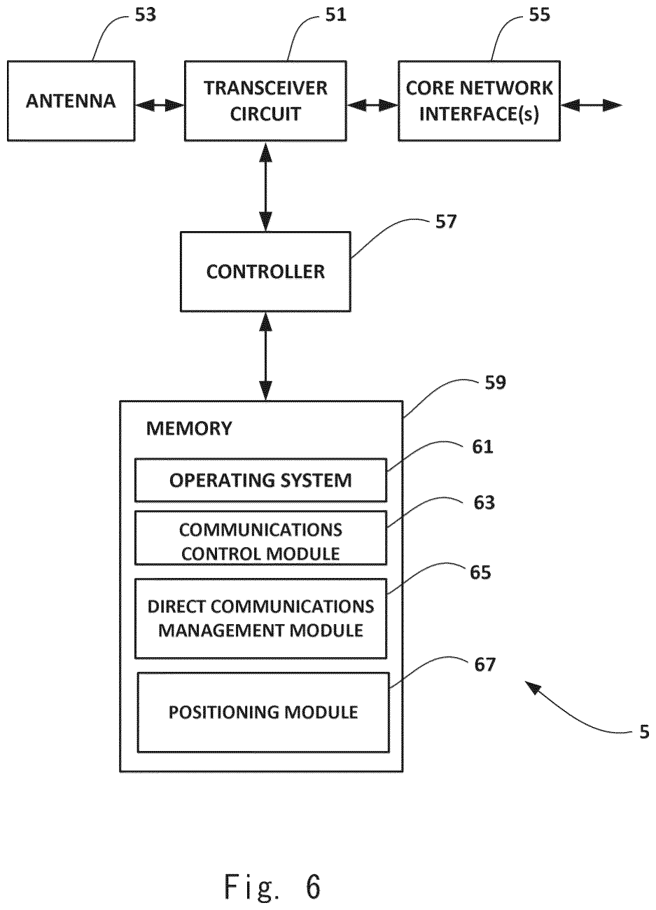

FIG. 6 is a schematic block diagram illustrating the main components of the base station 5 for the communication system 1 shown in FIG. 1. As shown, the base station 5 has a transceiver circuit 51 for transmitting signals to and for receiving signals from the communication devices (such as UEs 3) via one or more antennas 53 (e.g., an antenna array/massive antenna), and a core network interface 55 (e.g., comprising the N2, N3 and other reference points/interfaces) for transmitting signals to and for receiving signals from network nodes in the core network 7. Although not shown, the base station 5 may also be coupled to other base stations via an appropriate interface (e.g., the so-called ‘Xn’ interface in NR). The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59.

As shown, these software instructions include, among other things, an operating system 61, a communications control module 63, a direct communications management module 65, and a positioning module 67.

The communications control module 63 is operable to control the communication between the base station 5 and UEs 3 and other network entities that are connected to the base station 5. The communications control module 63 is configured for the overall control of the reception of uplink communications, via associated uplink channels (e.g., via a physical uplink control channel (PUCCH) and/or a physical uplink shared channel (PUSCH)) including both dynamic and semi-static signalling (e.g., SRS). The communications control module 63 is also configured for the overall handling of the transmission of downlink communications via associated downlink channels (e.g., via a physical downlink control channel (PDCCH) and/or a physical downlink shared channel (PDSCH)) including both dynamic and semi-static signalling (e.g., PRS).

The direct communications management module 65 is responsible for managing network-controlled aspects of direct UE-to-UE (i.e., sidelink) communication (e.g., for an in-coverage UE or an out-of-coverage UE that is communicating with an in-coverage UE in a partial coverage sidelink scenario). The direct communications module 65 is responsible, for example, for managing the transmission control information/configuration information for direct UE-to-UE communication to a UE 3 (e.g., in downlink control information (DCI) provided in the PDCCH, RRC or MAC signalling) possibly for relaying by a recipient UE to an out-of-coverage UE (e.g., via the PC5 interface (e.g., PC5-RRC signalling)). The control information/configuration information may include, for example, information for configuring the resource pools (shared and/or dedicated) and/or for allocating associated resources within those pools to be used by the UE 3 for direct UE-to-UE communication (including, for example, the transmission/reception of SL-PRS, and/or the transmission/reception of SL-PRS associated measurement reports).

The positioning module 67 is responsible for network side positioning related procedures including, for example performing measurements and generating associated measurement reports (e.g., time difference of arrival and/or the like) in respect of SRS from UEs. The positioning module 67 may communicate (via the communications control module 63) with a positioning function entity in the core network 7 such as the LMF 10-3.

### <Configuration of Resource Pools>

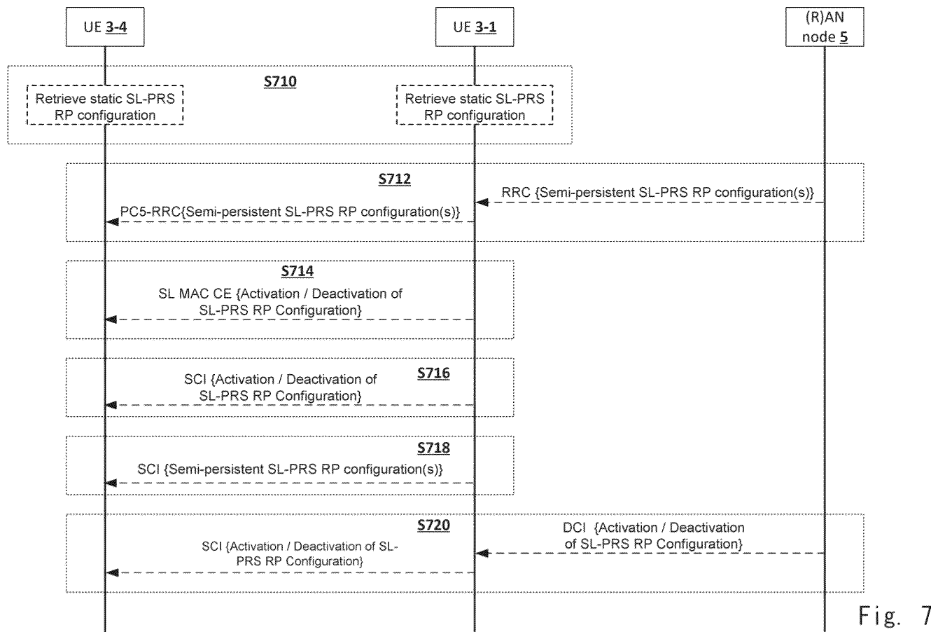

A number of techniques for configuring an SL-PRS resource pool at the UE 3-1, 3-2, 3-4 will now be described, by way of example only, in more detail with reference to FIG. 7. It will be appreciated that while the techniques are described with reference specifically to SL-PRS resource pools in general for ease of explanation, the frequency domain configuration may be applicable to any other resource pool described, for example a dedicated measurement report resource pool, a resource pool with multiplexed SL-PRS and data (measurement reports and/or other sidelink data), an RX resource pool, a TX resource pool, etc.

FIG. 7 is a simplified sequence diagram illustrating a number of different ways in which a UE 3 may be configured with a resource pool in the communication system 1.

As seen at S710, a resource pool may be preconfigured as a ‘static’ resource pool by configuration information stored in the UE 3 (e.g., in the UE's SIM). As seen at S710 such configurations can be retrieved (e.g., from the SIM) and applied by each UE 3 without further network configuration and hence can be used when the UE 3 is out-of-coverage and the network is not, therefore, involved.

As seen at S712, a resource pool may be configured as a ‘static’, or ‘semi-persistent’ resource pool by configuration information provided to one UE 3-4 by another UE 3-1 over the sidelink interface, for example in PC5-RRC signalling. As seen at S712 the a ‘static’, or ‘semi-persistent’ resource pool may also be configured by configuration information provided to a UE 3-1 from the base station 5 (e.g., in RRC signalling) if the UE 3-1 is in coverage of that base station 5. It will be appreciated that configuration information transmitted to one UE 3-4 from another UE 3-1 over the sidelink interface (e.g., via PC5-RRC) may have been provided to the transmitting UE 3-1 from the base station 5 (e.g., in RRC signalling), for example where the recipient UE 3-4 is out-of-coverage, and the transmitting UE 3-1 is in coverage.

If a resource pool has been preconfigured on the UE 3 then it will be appreciated that a configuration provided via PC5-RRC signalling from another UE 3 (and/or via RRC signalling from the base station 5) may override the preconfigured resource pool.

As seen at S714, one or more static or semi-persistent resource pool configurations (e.g., (pre)configured as shown at S710 and/or S712) of a UE 3 may be dynamically activated (or deactivated) dynamically using appropriate signalling over the sidelink interface (e.g., in a sidelink MAC control element (SL MAC CE) or the like).

As seen at S716, sidelink control information (first and/or second stage) may also be used to dynamically activate one or more static or semi-persistent resource pool configurations (e.g., (pre)configured as shown at S710 and/or S712) of a UE 3.

As seen at S718, sidelink control information may also be used to provide (additional) configuration information for (re)configuring one or more resource pools at the recipient UE 3. For example, additional configuration information may be fully conveyed in second stage SCI. The SCI may thus be used for configuration and/or activation, for example, simultaneous (re)configuration and/or activation of one or more resource pools. It will be appreciated that such an SCI (re)configuration may override a previously (pre)configured resource pool ((e.g., (pre)configured as shown at S710 and/or S712)).

As seen at S720, downlink control information (e.g., DCI format 3_0, which relates to scheduling of NR sidelink in one cell) in a PDCCH from a base station 5 may also be used for dynamically activating/deactivating (and/or possibly (re)configuring) one or more resource pools at a recipient UE 3 that is in-coverage. Alternatively, or additionally, configuration/activation/deactivation information provided in the DCI may be conveyed to another UE 3 (that may, for example, be out-of-coverage) in first stage and/or second stage SCI.

<Dedicated Resource Pools (No in-Slot SL-PRS/Measurement Report Multiplexing)>

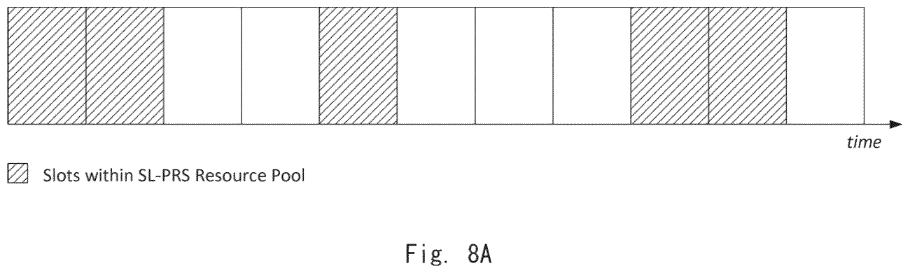

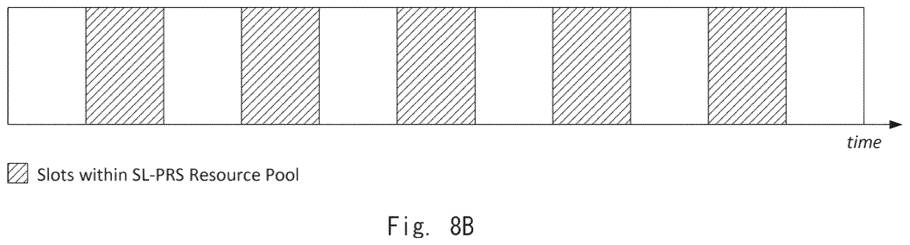

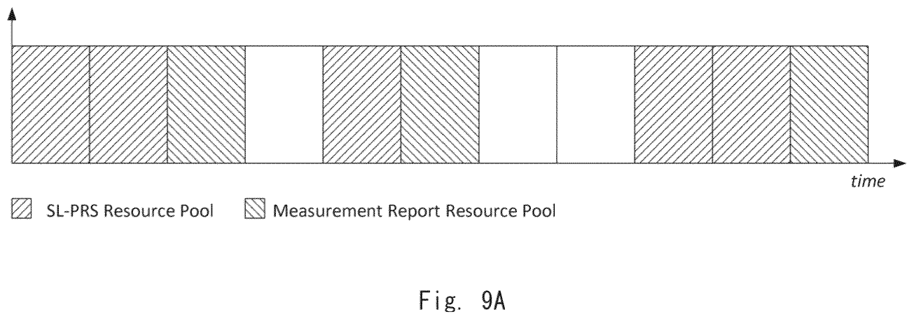

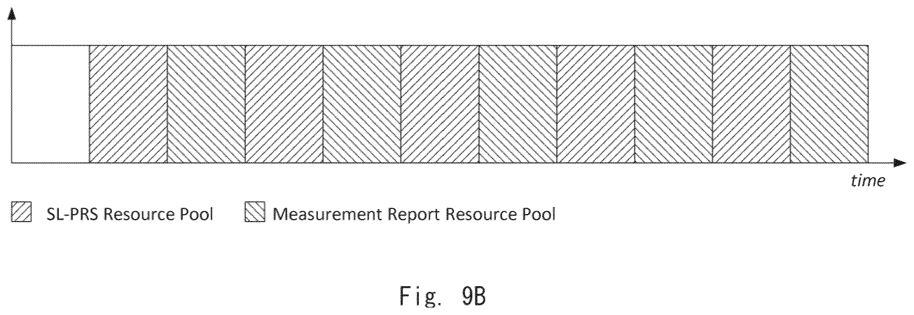

Exemplary techniques in which one or more dedicated resource pools may be (pre)configurable at the UE 3-1, 3-2, 3-4 will now be described in more detail with reference to FIGS. 8 and 9. In the techniques described with reference to FIGS. 8 and 9, one or more separate dedicated resource pools are respectively (pre)configured for transmission/reception of SL-PRS, and for transmission/reception of measurement reports.

FIGS. 8A and 8B each respectively illustrate a different possible timing configuration for an SL-PRS resource pool that may be used in the communication system 1. The SL-PRS resource pool illustrated in each of FIGS. 8A and 8B is an SL-PRS resource pool that includes SL-PRS transmissions without any transmissions of measurement reports (or other data).

In the configuration of FIG. 8A the slots within the SL-PRS resource pool are arranged in a non-uniform pattern. In this example, the pattern is configured by a bitmap in which each bit of the bitmap corresponds to a respective time resource (e.g., an individual slot, or a block of consecutive slots) in sequence and the value of the bit (‘1’ or ‘0’) represents whether that time resource is within the SL-PRS resource pool or not. It will, nevertheless, be appreciated that other configuration techniques are possible.

In the configuration of FIG. 8B the slots within the SL-PRS resource pool are arranged in a uniform pattern. While such a pattern may also be configured using a bitmap with appropriate bit settings, in this example, the pattern of FIG. 8B is configured by means of a periodicity at which time resources (e.g., an individual slot, or a block of consecutive slots) within the resource pool occur. Moreover, in this example, to provide greater configuration flexibility the uniform pattern is further configured by means of an offset indicating a timing at which a first time resource with the SL-PRS resource pool occurs relative to an appropriate fixed starting point (e.g., the start of a frame, half-frame, sub-frame, or resource pool in which sidelink communication may occur).

While use of a bitmap may have the benefit of simplicity, flexibility, and signalling efficiency, the use of a periodicity (and possibly offset) to indicate the SL-PRS time resources is particularly well suited to the efficient indication of a uniform (periodic regular) patterns, such as that shown in FIG. 8B. Such uniform patterns are beneficial in the context of SL-PRS which will likely need to be transmitted periodically.

As discussed above while, in this example, a dedicated SL-PRS resource pool is configured in which a measurement report (and other sidelink data) is not transmitted, this does not preclude the possible transmission of control information such as SCI. Accordingly, a PSCCH carrying first stage SCI and a PSSCH carrying second stage SCI could potentially be included with the SL-PRS within the same slot. The first and/or second stage SCI may, for example, be used to (re)configure, activate and/or deactivate SL-PRS.

It will be appreciated that, even where the PSCCH/PSSCH may be transmitted with the SL-PRS in the same slot, the SL-PRS resource pool may be configured such that PSCCH/PSSCH is not present in every slot of an SL-PRS resource pool. For example, the SL-PRS resource pool may be configured for transmission of the PSCCH/PSSCH in a subset of one or more slots (e.g., every nth slot, or a specific slot within every nth block of slots) within the SL-PRS resource pool. Accordingly, one or more slots within the SL-PRS resource pool may, beneficially, comprise SL-PRS signalling only (albeit that one or more AGC symbols and gap (switching) symbols might still be present), thereby providing a potentially greater resource capacity, and hence allowing more flexible resource allocation, for SL-PRS measurements across the available bandwidth (with the potential for improved accuracy in the corresponding positioning estimates made based on the SL-PRS measurements).

FIGS. 9A and 9B each respectively illustrate a different possible timing configuration for a dedicated measurement report resource pool that may be used in the communication system 1. The measurement report resource pool illustrated in each of FIGS. 9A and 9B is a measurement report resource pool that includes measurement result transmissions without any transmissions of other sidelink data or SL-PRS.

In the examples of FIGS. 9A and 9B, the timing of the dedicated measurement report resource pool is shown relative to the dedicated SL-PRS resource pool respectively illustrated in FIGS. 8A and 8B.

As seen in FIGS. 9A and 9B, the timing of the dedicated measurement report resource pools is (pre)configured to use time resources relative to those (pre)configured for the SL-PRS resource pool in order to meet one or more predefined or configured maximum latency requirements. Specifically, the timing pattern configured for a measurement reporting dedicated resource pool is configured to conform with (or to match) the timing pattern configured for the corresponding SL-PRS dedicated resource pool in a manner that effectively guarantees guarantee that measurement reports are transmitted no later than a set number (e.g., ‘k’) of time resources (e.g., slots, or blocks of consecutive slots) following those (pre)configured for a dedicated SL-PRS resource pool.

In the examples shown in FIGS. 9A and 9B the measurement report resource pool follows immediately after time resources configured for the dedicated SL-PRS resource pool. In the example of FIG. 9B a uniform timing pattern is configured for the dedicated measurement report resource pool in the same way as for the dedicated SL-PRS resource pool. While the time resources of the measurement report resource pool follow immediately after those of the SL-PRS resource pool in the illustrated examples it will, nevertheless, be appreciated that as long as the maximum latency requirement is met the time resources of the measurement report resource pool need not follow immediately after those of the SL-PRS resource pool.

For example, one or more time resources (slots/blocks of slots) for the measurement report resource pool can be configured to occur no later than a (pre)defined number, ‘k’, slot(s) after one or multiple SL-PRS resource pool slots, where the range of ‘k’ can be from 0 to a maximum (‘kmax’).

It will be appreciated that while the specific timing configuration for the measurement resource pools may be (pre)configured explicitly (e.g., from the base station, in negotiation with another UE, or from information stored on the SIM), the time configuration could be identified implicitly from a timing configuration (pre)configured for a corresponding dedicated SL-PRS resource pool (e.g., based on a (pre)configured maximum latency requirement and/or offset relative to the SL-PRS resource pool).

It will be appreciated that the same or different latency requirements may be (pre)configured for RX and TX measurement reporting resource pools. For example, from the perspective of a UE 3: a first maximum latency requirement (e.g., ‘T1’) may be (pre)configured between an RX SL-PRS resource pool and a TX measurement resource pool; and a second maximum latency requirement (e.g., ‘T2’) may be (pre)configured between a TX SL-PRS resource pool and an RX measurement resource pool.

<Dedicated Resource Pools (with in-Slot SL-PRS/Measurement Report Multiplexing)>

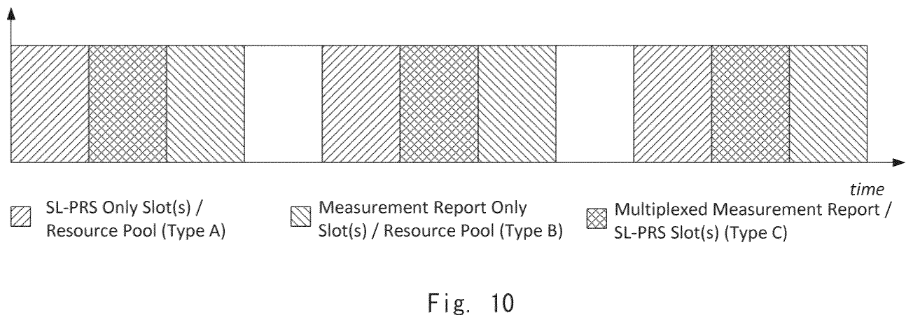

Another exemplary technique in which one or more dedicated resource pools may be (pre)configurable at the UE 3-1, 3-2, 3-4 will now be described in more detail with reference to FIG. 10, which illustrates a possible timing configuration for another dedicated resource pool that may be used in the communication system 1. In the example of FIG. 10, the (pre)configured dedicated resource may include SL-PRS transmissions multiplexed with transmissions of measurement reports.

Specifically, as seen in FIG. 10, a dedicated resource pool is (pre)configured in which each time resource (e.g., each slot or block of consecutive slots) may respectively be: a first type (e.g., ‘Type A’) for SL-PRS transmission/reception only time resource; a second type (e.g., ‘Type B’) for measurement report transmission/reception only; or a third type (e.g., ‘Type C’) for SL-PRS transmission/reception multiplexed with measurement report transmission/reception (and possibly PSFCH for HARQ if appropriate). It can be seen that, in this example, the first type of time resource for SL-PRS transmission/reception only can be understood to be part of a separate dedicated SL-PRS resource pool, the second type of time resource for measurement report transmission/reception only can be understood to be part of a separate dedicated measurement report resource pool, and the third type of time resource for SL-PRS transmission/reception multiplexed with measurement report transmission/reception can be understood to be an overlapping part of the dedicated SL-PRS resource pool and dedicated measurement report resource pool.

### <Use of Shared Resource Pools>

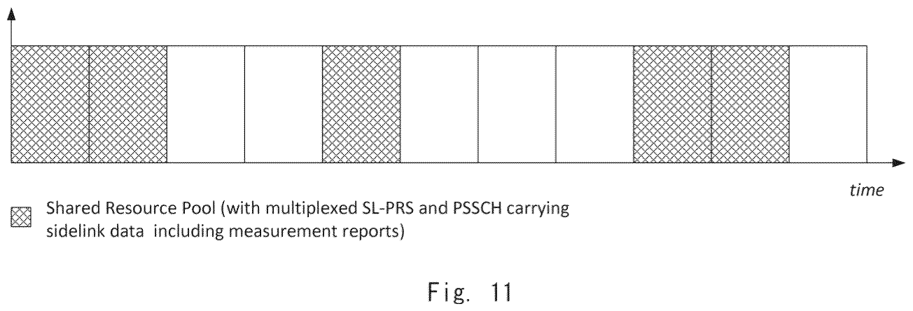

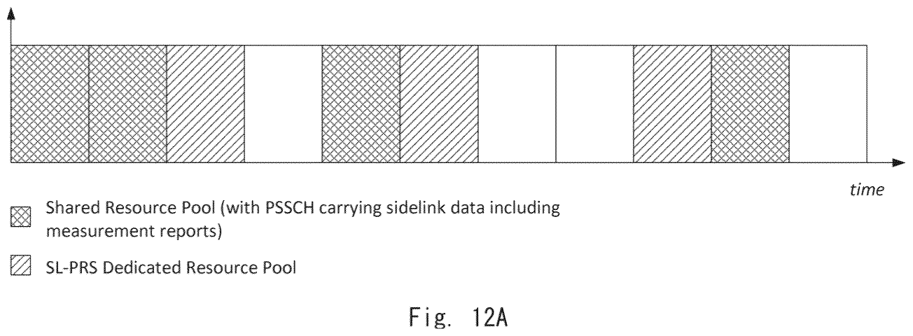

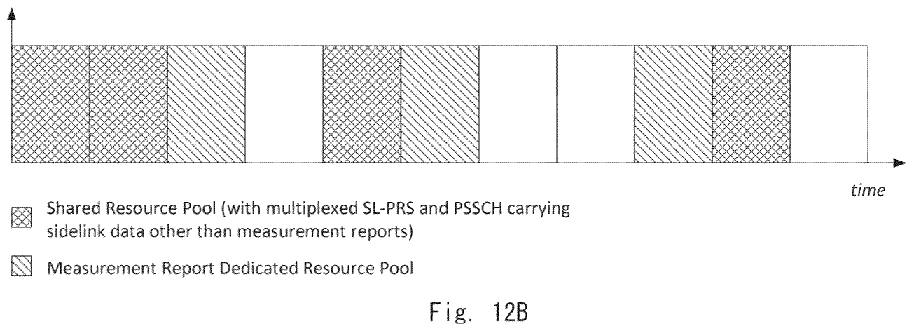

Exemplary techniques in which one or more shared resource pools may be (pre)configurable at the UE 3-1, 3-2, 3-4, and used for transmission of SL-PRS and/or measurement reports multiplexed with sidelink data, will now be described in more detail with reference to FIGS. 11 and 12. In the techniques described with reference to FIGS. 10 and 12, one or more pre(configured) shared sidelink resource pools may be one or more shared sidelink resource pools configured in the manner described with reference to FIG. 3.

FIG. 11 illustrates a possible timing configuration for a shared resource pool that may be used in the communication system 1. In the example of FIG. 11, the shared resource pool includes SL-PRS multiplexed with a PSSCH carrying sidelink data including measurement reports (and any appropriate control information such as second stage SCI). It will be appreciated that the shared resource pool may also include control information (e.g., first stage SCI) provided in a PSCCH and/or a PSFCH (and possibly AGC and switching symbols).

FIGS. 12A and 12B each respectively illustrate a possible timing configuration for a different possible technique involving a shared resource pool that may be used in the communication system 1.

Specifically, in the technique of FIG. 12A, a dedicated resource pool is (pre)configured for SL-PRS only whereas a shared resource pool is used for the transmission/reception of measurement reports (and other sidelink data). Similarly, in the technique of FIG. 12B, a dedicated resource pool is (pre)configured for measurement results only (without other data) and a shared resource pool may be used for the transmission/reception of other sidelink data multiplexed with SL-PRS.

### <Frequency Domain Configuration>

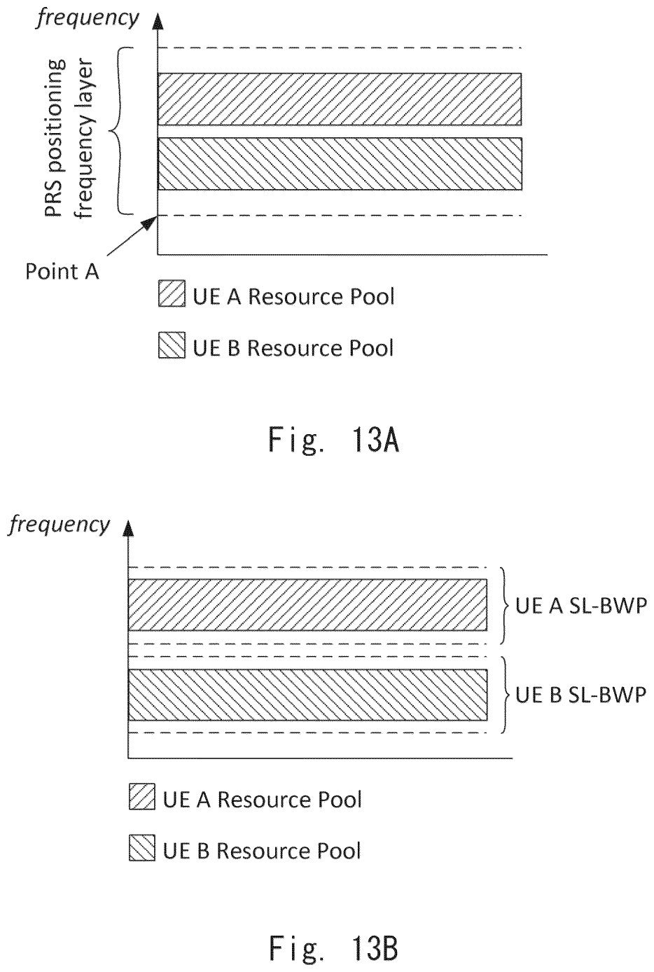

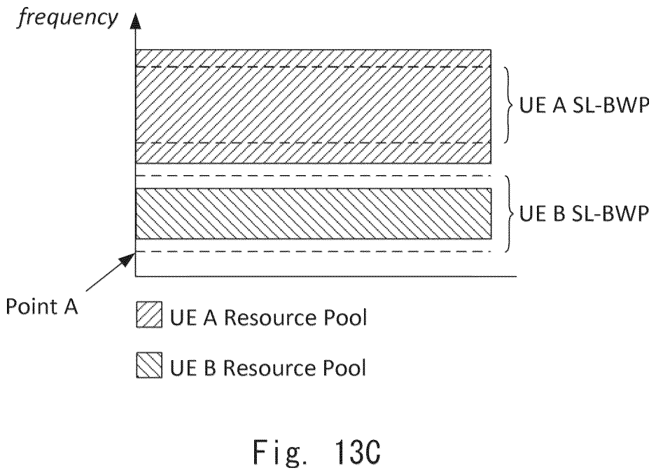

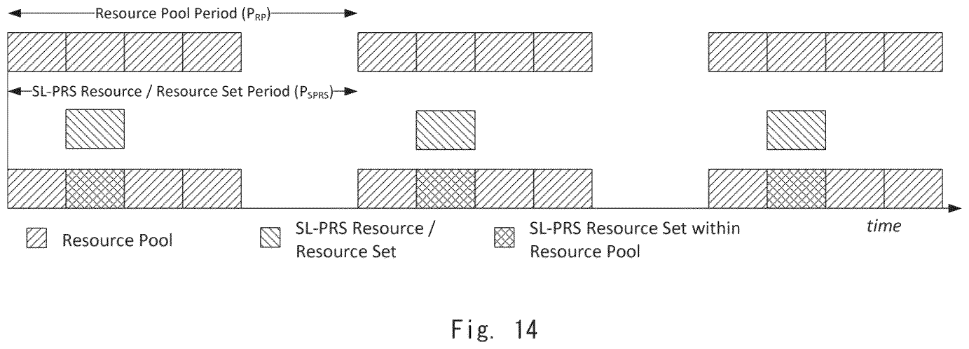

Possible techniques for frequency domain configuration of an SL-PRS resource pool will now be described, by way of example only, with reference to FIGS. 13A to 13C. It will be appreciated that while the techniques are described with reference specifically to SL-PRS resource pools in general for ease of explanation, the frequency domain configuration may be applicable to any other resource pool described, for example a dedicated measurement report resource pool, a resource pool with multiplexed SL-PRS and data (measurement reports and/or other sidelink data), an RX resource pool, a TX resource pool, etc.

FIGS. 13A to 13C each respectively illustrate a different possible frequency domain configuration for the SL-PRS resource pool that may be used in the communication system 1.

In FIG. 13A the frequency resources configured for an SL-PRS resource pool for a given UE are configured with respect to a predefined positioning frequency layer (also known as a PRS positioning frequency layer).

A positioning frequency layer is defined as a collection of frequency resource sets with each frequency resource set defining a collection of frequency resources. The resource sets defined in the positioning frequency layer are configured based on a number of common parameters including: a subcarrier spacing for all resource sets in the positioning frequency layer (e.g., specified as 15, 30, 60, or 120); a cyclic prefix for all resource sets in the positioning frequency layer (e.g., specified as ‘normal’ or ‘extended’), and a common frequency point (‘Point A’) with respect to which resource allocations for PRS may be defined. Point A may, for example, be seen as an absolute frequency corresponding to the lowest subcarrier of a reference resource block or a common resource block.

Accordingly, for sidelink positioning, a SL-PRS resource pool for one UE can be configured to be within a predefined (sidelink) positioning frequency layer relative to point A. In this way plural SL-PRS resource pools for plural UEs can be configured to be within a common predefined positioning frequency layer relative to point A as seen for UE A and UE B in FIG. 13A.

It will be appreciated that for sidelink, the available resources for SL-PRS could, as a result of this technique, be quite dynamic with SL-PRS resource pools being non-overlapping, partially overlapping, or fully overlapping (i.e., resource pools shared, at least in part, by more than one device).

A frequency configuration for a specific SL-PRS resource pool for a given UE 3 may be provided in any suitable form to that UE 3, for example it may be preconfigured, negotiated with another UE 3 via sidelink communication, signalled in RRC signalling from a base station (if the UE is in-coverage), provided by lower layer signalling (e.g., first stage and/or second stage SCI).

In FIG. 13B the frequency resources configured for an SL-PRS resource pool for a given UE 3 are configured with respect to a SL-BWP configured for that UE 3.

Specifically, frequency resources for an SL-PRS resource pool for the UE 3 correspond to the frequency resources of the SL-BWP configured for the UE 3. It will be appreciated that the frequency resources for an SL-PRS may have a bandwidth and starting frequency resource (e.g., a starting resource block) that matches the SL-BWP exactly or may be (pre)configured to have a smaller bandwidth that is entirely within the SL-BWP (e.g., by an amount corresponding to a frequency offset from the upper and/or a frequency offset lower end of the SL-BWP).

It will be appreciated that in this case there may, beneficially, be no need to provide additional configuration information (e.g., in addition to the SL-BWP configuration), whether by signalling from another communication entity or from the SIM card, to inform the UE 3 of the frequency configuration of the SL-PRS resource pool because the UE 3 can implicitly determine the frequency configuration of the SL-PRS resource pool from the SL-BWP configuration.

In FIG. 13C the frequency resources configured for an SL-PRS resource pool for a given UE 3 are configured with respect to both the positioning frequency layer (e.g., as described with respect to FIG. 13A), and an SL-BWP configured for that UE 3.

In the illustrated example, the SL-PRS resource pool can be configured to have a wider bandwidth than the SL-BWP for that device (as seen for UE A). It will be appreciated that in a case where a wider bandwidth is configured for a UE 3 to receive (and hence measure) the SL-PRS, then a measurement gap (i.e., a specific opportunity for that UE 3 to perform measurements of the SL-PRS during which the UE does not perform transmission or reception) could be configured for a UE 3 to support measurement of the S-PRS resources within such a wider bandwidth SL-PRS resource pool. Whether or not a resource pool can be configured with a wider bandwidth than the SL-BWP for that device could depend on a UEs capability.

It will be appreciated that the possibility of measuring SL-PRS over a wider bandwidth than the potentially limited SL-BWP bandwidth thereby providing the potential for improved accuracy in the corresponding positioning estimates made based on the SL-PRS measurements.

It will also be appreciated that where frequency domain configuration for the resource pool needs to be provided to a UE 3 then it may be provided using any suitable signalling (e.g., from a SIM, another UE 3 and/or base station 5). For example, frequency domain configuration information for a resource pool may be provided (if needed) to a UE 3 using any of the techniques described with reference to FIG. 7.

### <Time Domain Configuration>

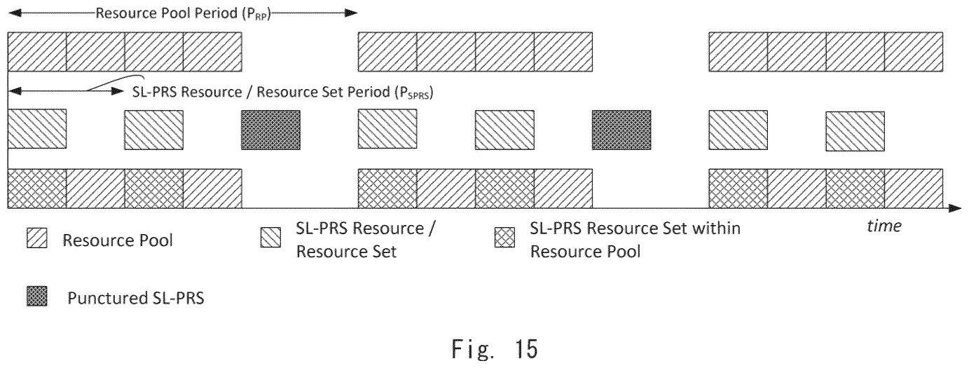

Possible techniques for time domain configuration of an SL-PRS resource pool will now be described, by way of example only, with reference to FIGS. 14 to 17. It will be appreciated that while the techniques are described with reference specifically to SL-PRS resource pools in general for ease of explanation, the time domain configuration may be applicable to any other resource pool described, for example a dedicated measurement report resource pool, a resource pool with multiplexed SL-PRS and data (measurement reports and/or other sidelink data), an RX resource pool, a TX resource pool, etc.

It will be appreciated that for sidelink positioning as the position of one UE 3 may be determined relative to another UE 3 known as an anchor UE, and the anchor UE may move, it is advantageous for the transmissions/measurements of the SL-PRS used to determine the position to occur closely to one another in the time domain (e.g., in consecutive time windows). Whilst the granularity of the resource pool may be a single slot, therefore, the granularity may be a plurality of (say ‘n’) consecutive slots forming a time slot block (TSB). The configuration in the time domain may be based on such a TSB using either a bitmap or periodicity (and possibly offset) essentially as described previously.

It will also be appreciated that the slots used for the SL-PRS resource pool may comprise only slots configured as uplink slots and/or slots containing symbols configured as uplink symbols. This ensures that the slots for the SL-PRS resource pool are UE transmission slots.

It will also be appreciated that a time domain configuration for the resource pool may be provided to a UE 3 (e.g., from a SIM, another UE 3 and/or base station 5) using any suitable signalling. For example, the time domain configuration for the resource pool may be provided to a UE 3 using any of the techniques described with reference to FIG. 7.

In order to configure specific time resources (or sets of time resources) for a UE 3, two different periods may be configured, a resource pool period (P_{RP}) and a time resource/time resource set period (P_{SPRS}). The resource pool period (P_{RP}) defines the periodicity of the SL-PRS resource pool (which may correspond to the (pre)configured periodicity described with reference to FIG. 8(b) or may correspond to the periodicity of a shared sidelink resource pool such as that shown in FIG. 3). The time resource/time resource set period (P_{SPRS}) defines a periodicity of the time resources/time resource set within the resource pool.

FIGS. 14 to 16 each illustrate a respective time domain resource pool configuration scenario that may occur in the communication system 1. FIGS. 14 to 16 each illustrate how specific SL-PRS time resources, or sets of time resources, may be configured for transmission/reception of one or more SL-PRSs by a UE 3, by reference to the two periods.

In FIG. 14 the resource pool period (P_{RP}) and time resource/time resource set period (P_{SPRS}) are equal (P_{RP}=P_{SPRS}). Hence, as seen in FIG. 14, at least a single SL-PRS resource/resource set (and hence at least a single SL-PRS) is configurable within the respective time resources of the SL-PRS resource pool that occur each resource pool period. The configured SL-PRS resource/resource set is then repeated periodically (multiple times) at the same relative time location within each subsequent periodic occurrence of the time resources within the SL-PRS resource pool (i.e., at the periodicity P_{SPRS}(=P_{RP})).

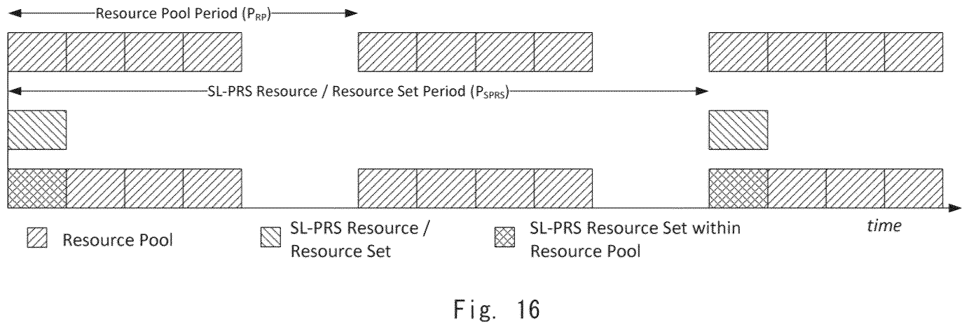

In FIG. 15 the resource pool period is greater than the time resource/time resource set period (P_{RP}>P_{SPRS}). Hence, as seen in FIG. 15, plural SL-PRS resources/resource sets (and hence plural SL-PRS) are configurable within the respective time resources of the SL-PRS resource pool that occur each resource pool period. In this scenario the timing occasions corresponding to the time resources of the SL-PRS resource pool set may not always coincide with time resources of the SL-PRS resource pool. In this case the corresponding SL-PRS may be punctured to ensure an effective periodicity of the SL-PRS resource/resource set (and the corresponding plural SL-PRS) that matches the resource pool period as illustrated in FIG. 15.

In FIG. 16 the resource pool period is less than the time resource/time resource set period (P_{RP}<P_{SPRS}). Hence, as seen in FIG. 16, the SL-PRS resources/resource sets (and hence SL-PRS) may be configurable such that the respective time resources of the SL-PRS resource pool that occur in one or more resource pool periods contain no SL-PRS resources/resource sets (and hence SL-PRS) for that UE.

In the above examples the two periods may be (pre)configured independently of one another or one (e.g., P_{RP}) may be configured to be an integer multiple (or divisor) of the other (e.g., P_{SPRS}).

It will be appreciated that the resource pool periodicity may be configured to be any of a number of periodicities (e.g., 10240, 5120, 2560, 1280, 640, 320, 160, 80, 40, 20, 10, and/or 5 time unit), where time unit depends on numerology. Beneficially, each configurable periodicity (other than the shortest periodicity) may be double the next longest periodicity thereby ensuring that the resource pool occasions corresponding to longer periods coincide with those of shorter periods.

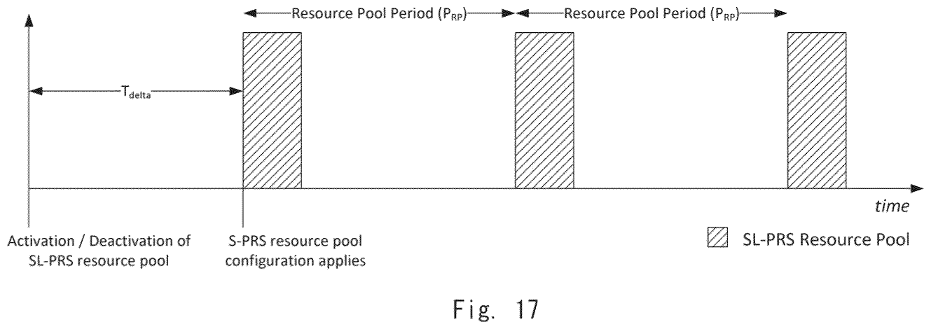

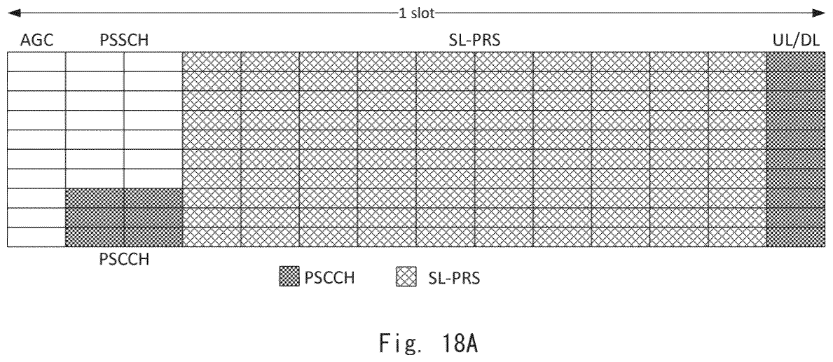

FIG. 17 illustrates another time domain time domain configuration technique that may be used in the communication system 1.

In the technique illustrated in FIG. 17 a time period/timer (T_{delta}) is configured to indicate a length of time, following activation (or deactivation) of an S-PRS resource pool, before the corresponding SL-PRS resource pool configuration starts to be (or stops being) applied. Alternatively, the time period/timer (T_{delta}) may be configured to indicate a length of time following transmitter/receiver switching of the configuration before the corresponding SL-PRS resource pool configuration (is activated and) starts to be applied.

### <Multiplexing Modes>

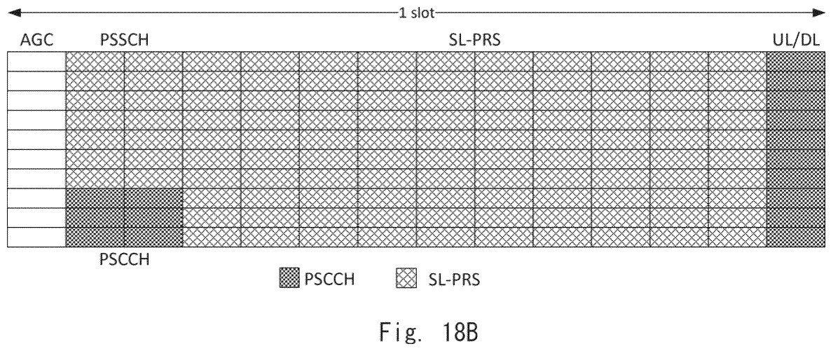

Possible techniques for multiplexing of SL-PRS and other signalling will now be described, by way of example only, with reference to FIGS. 18 to 20. It will be appreciated that in a first ‘multiplexing’ mode (e.g., ‘Mode 1’) only SL-PRS are transmitted in a slot and so there is no multiplexing. FIGS. 18 to 20 illustrate a number of different possible other modes for multiplexing of SL-PRS with other signalling in the communication system 1.

FIGS. 18A and 18B each illustrate a respective variation of a multiplexing mode that may be used in the communication system 1. In the illustrated multiplexing mode (e.g., ‘Mode 2’) the PSCCH (e.g., first stage SCI) is multiplexed with the SL-PRS. In the variation of the multiplexing mode (e.g., ‘Mode 2a’) shown in FIG. 18A the PSCCH (e.g., first stage SCI) is only multiplexed with the SL-PRS in the time domain. In the example, the second and third symbols in the slot are used for the PSCCH only whereas the fourth to thirteenth symbols are used for SL-PRS only.

In the variation of the multiplexing mode (e.g., ‘Mode 2b’) shown in FIG. 18A the PSCCH (e.g., first stage SCI) is multiplexed with the SL-PRS in both the time and the frequency domain. In the example, the second and third symbols in the slot are still used for the PSCCH. However, in this example, the SL-PRS are frequency multiplexed with the PSCCH in the second and third symbols. The fourth to thirteenth symbols are still used for SL-PRS only.

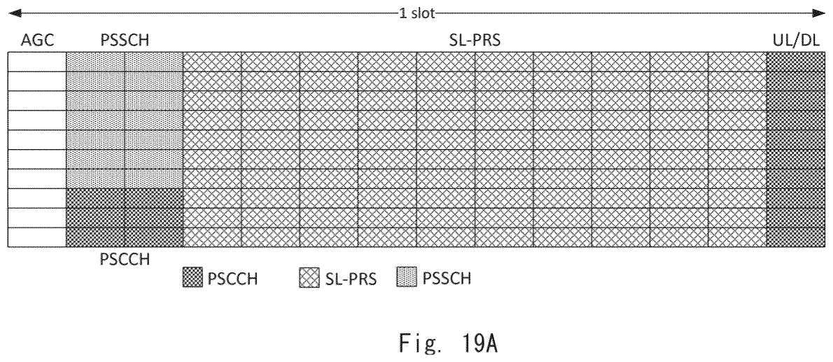

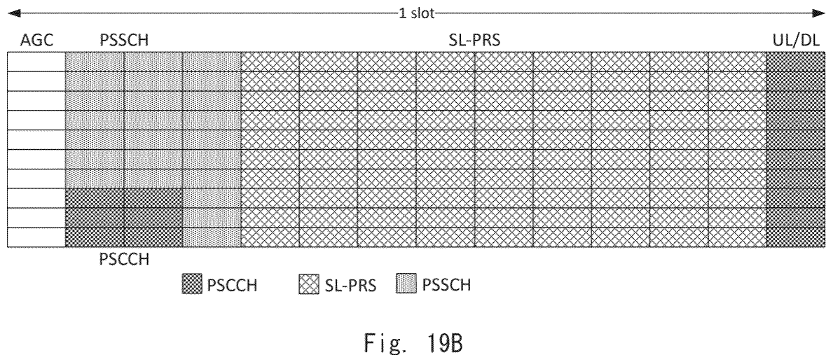

FIGS. 19A and 19B each illustrate another respective multiplexing mode that may be used in the communication system 1.

In the multiplexing mode (e.g., ‘Mode 3’) shown in FIG. 19A the PSCCH (e.g., first stage SCI) and the SCI sent in the PSSCH (e.g., second stage SCI) is multiplexed with the SL-PRS in the time domain with the same symbols allocated to the PSSCH and PSCCH. Hence, the PSSCH is transmitted in the second and third symbols in the slot along with the PSCCH. The fourth to thirteenth symbols are used for SL-PRS only.

In the multiplexing mode (e.g., ‘Mode 4’) shown in FIG. 19B the PSCCH (e.g., first stage SCI), the SCI sent in the PSSCH (e.g., second stage SCI) and other data (e.g., measurement reports and/or other sidelink data) are multiplexed with the SL-PRS in the time domain. In this example the symbols allocated to the PSSCH and PSCCH are different with the PSSCH being transmitted in the second, third and fourth symbols in the slot and the PSCCH only being transmitted in the second and third. The fifth to thirteenth symbols are used for SL-PRS only.

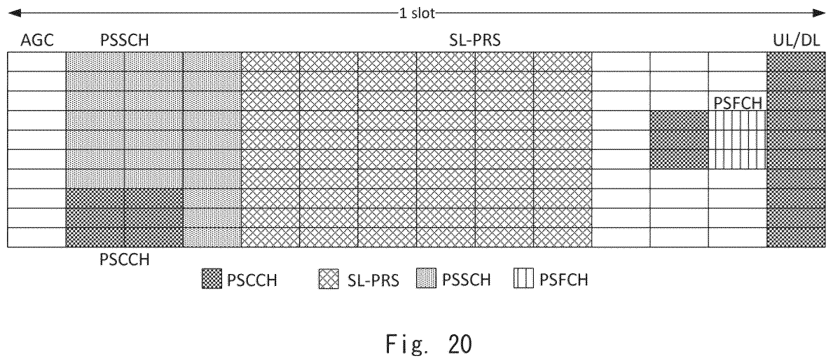

FIG. 20 illustrates another possible multiplexing mode that may be used in the communication system 1.

In the multiplexing mode (e.g., ‘Mode 5’) shown in FIG. 20 the PSCCH (e.g., first stage SCI), the SCI sent in the PSSCH (e.g., second stage SCI) and other data (e.g., measurement reports and/or other sidelink data) are multiplexed with the SL-PRS in the time domain. As with the multiplexing mode illustrated in FIG. 19B, in this example the symbols allocated to the PSSCH and PSCCH are different with the PSSCH being transmitted in the second, third and fourth symbols in the slot and the PSCCH only being transmitted in the second and third. However, in this mode the PSFCH (e.g., for HARQ feedback) is also multiplexed with the SL-PRS in the time domain (in the thirteenth symbol in this example) with appropriate guard elements provided in the preceding symbol. The fifth to tenth symbols are used for SL-PRS only.

It will be appreciated that all, or a subset of one or more, of the multiplexing modes may be provided in the communication system depending on requirements. For example, Mode 1, 2A, 2B and 3 are applicable for dedicated SL-PRS resource pools (without inclusion of measurement reports). Modes 4 and 5 are applicable for dedicated resource pools that can include both SL-PRS and measurement reports (without other sidelink data). Modes 4 and 5 are also applicable for shared resource pools that can include SL-PRS together with measurement reports and/or other sidelink data.

### <Modifications and Alternatives>

Detailed examples have been described above along with a number of variations and alternatives. As those skilled in the art will appreciate, a number of modifications and alternatives can be made to the above examples whilst still benefiting from the disclosures embodied therein.

It will be appreciated, for example, that the various configuration solutions described above for a specific technique (e.g., involving a dedicated and/or a shared resource pool) may also be applied to in respect of the other techniques. For example, the use of a timing configuration for one or more measurement reporting resource pools that matches or corresponds to that of one or more SL-PRS resource pools is generally applicable since keeping latency within known limits is generally beneficial.

It will also be appreciated that multiple resource pools may be configured for a single device. In this context the maximum number of dedicated SL-PRS resource pools and/or the maximum number of dedicated measurement resource pools may potentially be configured based on UE capability. Similarly, the maximum number of dedicated resource pools and/or the maximum number of dedicated measurement resource pools in which both SL-PRS and measurement reports are allowed may potentially be configured based on UE capability. Alternatively, or additionally, a maximum (total) number of resource pools, may potentially be configured depending based on UE capability, and may be divided respectively into a set of resource pools for SL-PRS and a set of resource pools for measurement reports (and/or possibly a set of resource pools in which both SL-PRS and measurement reports are allowed).

It will also be appreciated that a single resource pool will typically be shared by more than one device (possibly multiple devices). In this context, a dedicated SL-PRS only resource pool may, beneficially, only be shared for SL-PRS transmission/reception. Beneficially, to inhibit the possibility of such resource pools being used for other transmission/reception, an indication may be configured to inform other UEs that the resource pools are reserved for SL-PRS transmission/reception so that the other UEs do not try to use the corresponding resources for data transmission (either measurement report or other SL data). Similarly, to inhibit the possibility of a dedicated measurement report only resource pool being used for other transmission/reception, an indication may be configured to inform other UEs that the resource pools are reserved for measurement report only transmission/reception so that the other UEs do not try to use the corresponding resources for transmission/reception of other sidelink data or SL-PRS. Such an indication may, for example, be provided in sidelink control information (e.g., 1^{st} stage and/or possibly 2^{nd} stage).

Moreover, whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part, or all of, this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following Table 2. This list is not exhaustive and is intended to be indicative of some examples of machine type communication applications.

TABLE 2

| Service Area | MTC applications |
|---|---|
| Security | Surveillance systems |
| | Backup for landline |
| | Control of physical access (e.g., to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

Although the present disclosure has been described with reference to the exemplary embodiments, the present disclosure is not limited to the above. Various changes that can be understood by those skilled in the art can be made to the configuration and details of the present disclosure within the scope of the disclosure.

This application is based upon and claims the benefit of priority from UK patent application No. 2210582.9, filed on Jul. 19, 2022, the disclosure of which is incorporated herein in its entirety by reference.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

For example, the whole or part of the exemplary embodiments disclosed above can be described as, but not limited to, the following supplementary notes.

### (Supplementary Note 1)

A method performed by a user equipment (UE), the method comprising:
transmitting a positioning reference signal (PRS) to, or receiving a PRS from, at least one further UE using a communication resource of at least one resource pool which is configured based on configuration information including first information for at least one resource pool that includes the communication resource for at least one of: transmission of a PRS to, or reception of a PRS from, the at least one further UE,
wherein the first information defines at least one pattern of a time domain resource for the at least one resource pool.

### (Supplementary Note 2)

The method according to supplementary note 1, wherein the configuration information includes information for configuring at least one dedicated direct UE-to-UE PRS resource pool for transmission or reception of direct UE-to-UE PRS.

### (Supplementary Note 3)

The method according to supplementary note 2, wherein the information for configuring at least one dedicated direct UE-to-UE PRS resource pool is arranged for configuring a number of dedicated direct UE-to-UE PRS resource pools, wherein the number of dedicated direct UE-to-UE PRS resource pools is no greater than a maximum number of dedicated direct UE-to-UE PRS resource pools, and the maximum number of dedicated direct UE-to-UE PRS resource pools depends on a capability of the UE.

### (Supplementary Note 4)

The method according to any one of supplementary notes 1 to 3, wherein the configuration information includes information for configuring at least one dedicated measurement report resource pool for transmission or reception of at least one measurement report including PRS measurement results.

### (Supplementary Note 5)

The method according to supplementary note 4, wherein the information for configuring at least one dedicated measurement report resource pool is arranged for configuring a number of dedicated measurement report resource pools, wherein the number of dedicated measurement report resource pools is no greater than a maximum number of dedicated measurement report resource pools, and the maximum number of dedicated measurement report resource pools depends on a capability of the UE.

### (Supplementary Note 6)

The method according to any one of supplementary notes 4 to 5, wherein the information for configuring at least one dedicated measurement report resource pool is arranged for configuring a time domain resource for the at least one dedicated measurement report resource pool based on a latency requirement for measurement reporting.

### (Supplementary Note 7)

The method according to supplementary note 6, wherein the information for configuring at least one dedicated measurement report resource pool is arranged for configuring a time domain resource for the at least one dedicated measurement report resource pool based on a different latency requirement for a resource pool for receiving at least one measurement report than for a resource pool for transmitting at least one measurement report.

### (Supplementary Note 8)

The method according to any one of supplementary notes 4 to 7, wherein the information for configuring at least one dedicated measurement report resource pool is arranged for configuring at least one time domain resource for the at least one dedicated measurement report resource pool to be no greater than a maximum number of time domain resources after at least one time domain resource configured for the at least one dedicated direct UE-to-UE PRS resource pool.

### (Supplementary Note 9)

The method according to any one of supplementary notes 1 to 8, wherein the configuration information includes information for configuring a total number of resource pools, wherein the total number of resource pools is no greater than a maximum total number of resource pools, and the maximum total number of resource pools depends on a capability of the UE.

### (Supplementary Note 10)

The method according to any one of supplementary notes 1 to 9, wherein the PRS is respectively transmitted, or respectively received, with direct UE-to-UE control information in each time domain resource of at least a first subset of at least one time domain resource configured for the at least one resource pool.

### (Supplementary Note 11)

The method according to supplementary note 10, wherein the PRS is respectively transmitted, or respectively received, without direct UE-to-UE control information in each time domain resource of at least a second subset of the time domain resources configured for the at least one resource pool.

### (Supplementary Note 12)

The method according to supplementary note 11, wherein the first subset of the time domain resources occur at regular intervals within the time domain resources configured for the at least one resource pool.

### (Supplementary Note 13)

The method according to any one of supplementary notes 1 to 12, wherein the first information defines a pattern of a time domain resource in which time domain resources for the at least one resource pool occur at regular time intervals.

### (Supplementary Note 14)

The method according to any one of supplementary notes 1 to 13, wherein the first information defines at least one periodicity for the at least one pattern.

### (Supplementary Note 15)

The method according to supplementary note 14, wherein the first information defines a first periodicity for at least one time domain resource of the at least one resource pool, and a second periodicity for at least one time domain resource within which a PRS is to be transmitted to, or received from, the at least one further UE.

### (Supplementary Note 16)

The method according to supplementary note 15, wherein the first information defines the second periodicity independently from the first periodicity.

### (Supplementary Note 17)

The method according to supplementary note 15, wherein the first information defines the second periodicity to be an integer multiple of, or integer devisor of, the first periodicity.

### (Supplementary Note 18)

The method according to any one of supplementary notes 14 to 17, wherein the at least one periodicity is dependent on a communication numerology configured for the UE.

### (Supplementary Note 19)

The method according to any one of supplementary notes 14 to 18, wherein the at least one periodicity is selected from a set of possible periodicities.

### (Supplementary Note 20)

The method according to supplementary note 19, wherein each periodicity of the set of possible periodicities, except the shortest periodicity, is twice the next longest periodicity of the set of possible periodicities.

### (Supplementary Note 21)

The method according to any one of supplementary notes 1 to 20, wherein the first information defines at least one offset for the at least one pattern.

### (Supplementary Note 22)

The method according to any one of supplementary notes 1 to 21, wherein the first information defines at least one time delay after which the at least one resource pool is to be activated.

### (Supplementary Note 23)

The method according to any one of supplementary notes 1 to 22, wherein the configuration information includes information for configuring at least one dedicated direct UE-to-UE PRS and measurement report resource pool for transmission or reception of direct UE-to-UE PRS, and for transmission or reception of at least one measurement report including PRS measurement results.

### (Supplementary Note 24)

The method according to supplementary note 23, wherein the at least one dedicated direct UE-to-UE PRS and measurement report resource pool includes at least one time domain resource configured for transmission or reception of direct UE-to-UE PRS without transmission or reception of a measurement report including PRS measurement results.

### (Supplementary Note 25)

The method according to supplementary note 23 or 24, wherein the at least one dedicated direct UE-to-UE PRS and measurement report resource pool includes at least one time domain resource configured for transmission or reception of at least one measurement report including PRS measurement results without transmission or reception of direct UE-to-UE PRS.

### (Supplementary Note 26)

The method according to supplementary note 23, 24, or 25, wherein the at least one dedicated direct UE-to-UE PRS and measurement report resource pool includes at least one time domain resource configured for transmission or reception of direct UE-to-UE PRS multiplexed with transmission or reception of at least one measurement report including PRS measurement results.

### (Supplementary Note 27)

The method according to any one of supplementary notes 23 to 26, wherein the configuration information includes information for configuring at least one shared resource pool, and at least one of the PRS, or a measurement report including PRS measurement results, is respectively transmitted, or respectively received, with direct UE-to-UE data of a physical sidelink shared channel (PSSCH) in at least one time domain resource of the at least one shared resource pool.

### (Supplementary Note 28)

The method according to any one of supplementary notes 1 to 27, wherein the first information defines the at least one pattern of a time domain resource with a granularity of a number, n, of slots, where n is greater than or equal to 1.

### (Supplementary Note 29)

The method according to supplementary note 28, wherein the first information defines the at least one pattern of a time domain resource with a granularity of a plurality of consecutive slots.

### (Supplementary Note 30)

The method according to any one of supplementary notes 1 to 29, wherein at least one of the configuration information, or activation information for activating or deactivating at least one resource pool configuration, is received from another UE.

### (Supplementary Note 31)

The method according to supplementary note 30, wherein the at least one of the configuration information, or the activation information, is received in direct UE-to-UE control information from the another UE.

### (Supplementary Note 32)

The method according to any one of supplementary notes 1 to 31, wherein at least one of the configuration information, or activation information for activating or deactivating at least one resource pool configuration, is received from an access network node.

### (Supplementary Note 33)

The method according to supplementary note 32, wherein the at least one of the configuration information, or the activation information, is received in downlink control information from the access network node.

### (Supplementary Note 34)

The method according to any one of supplementary notes 1 to 33, wherein configuration information includes frequency layer information defining a frequency layer for PRS, wherein the configuration information includes information for configuring at least one frequency domain resource for the at least one resource pool, based on the frequency layer information, to be within the frequency layer for PRS.

### (Supplementary Note 35)

The method according to any one of supplementary notes 1 to 34, wherein the configuration information includes bandwidth part (BWP) information defining a BWP for direct UE-to-UE communication, and information for configuring at least one frequency domain resource for the at least one resource pool, based on the BWP information, to be at least partially within the BWP for direct UE-to-UE communication.

### (Supplementary Note 36)

The method according to supplementary note 35, wherein the information for configuring at least one frequency domain resource is arranged for configuring the at least one frequency domain resource to have a bandwidth that is wholly within a bandwidth of the BWP.

### (Supplementary Note 37)

The method according to supplementary note 35 or 36, wherein the information for configuring at least one frequency domain resource is arranged for configuring the at least one frequency domain resource to have a bandwidth that extends beyond at least one edge of the BWP in frequency, and the configuration information includes information for configuring a measurement gap for the measurement of PRS transmitted within the at least one resource pool.

### (Supplementary Note 38)

The method according to supplementary note 35, 36, or 37 wherein the information for configuring at least one frequency domain resource is arranged for configuring the at least one frequency domain resource to have a bandwidth that is wholly within a bandwidth of the BWP or to have a bandwidth that extends beyond at least one edge of the BWP in frequency based on a capability of the UE.

### (Supplementary Note 39)

The method according to any one of supplementary notes 1 to 38, wherein the PRS is respectively transmittable or receivable in each time domain resource in accordance with at least one multiplexing mode.

### (Supplementary Note 40)

The method according to supplementary note 39, wherein the at least one multiplexing mode includes a multiplexing mode in which the PRS is transmitted or received without being multiplexed with data or control information in a corresponding time domain resource.

### (Supplementary Note 41)

The method according to supplementary note 39 or 40, wherein the at least one multiplexing mode includes a multiplexing mode in which the PRS is multiplexed, with control information provided in a direct UE-to-UE control channel, in a corresponding time domain resource without frequency domain multiplexing of the PRS with that control information.

### (Supplementary Note 42)

The method according to supplementary note 39, 40, or 41, wherein the at least one multiplexing mode includes a multiplexing mode in which the PRS is multiplexed, with control information provided in a direct UE-to-UE control channel, in a corresponding time domain resource with frequency domain multiplexing of the PRS with that control information.

### (Supplementary Note 43)

The method according to any one of supplementary notes 39 to 42, wherein the at least one multiplexing mode includes a multiplexing mode in which the PRS is multiplexed, with control information provided in a direct UE-to-UE control channel and with control information provided in a direct UE-to-UE shared channel, in a corresponding time domain resource.

### (Supplementary Note 44)

The method according to any one of supplementary notes 39 to 43, wherein the at least one multiplexing mode includes a multiplexing mode in which the PRS is multiplexed, with control information provided in a direct UE-to-UE control channel and with control information and data provided in a direct UE-to-UE shared channel, in a corresponding time domain resource.

### (Supplementary Note 45)

The method according to any one of supplementary notes 39 to 44, wherein the at least one multiplexing mode includes a multiplexing mode in which the PRS is multiplexed, with control information provided in a direct UE-to-UE control channel, with control information and data provided in a direct UE-to-UE shared channel, and with feedback provided in a direct UE-to-UE feedback channel, in a corresponding time domain resource.

### (Supplementary Note 46)

A user equipment (UE) comprising:
means for transmitting a positioning reference signal (PRS) to, or receiving a PRS from, at least one further UE using a communication resource of at least one resource pool which is configured based on configuration information including first information for at least one resource pool that includes the communication resource for at least one of: transmission of a PRS to, or reception of a PRS from, the at least one further UE,
wherein the first information defines at least one pattern of a time domain resource for the at least one resource pool.

### (Supplementary Note 47)

A method performed by an access network node, the method comprising:
transmitting, to a user equipment (UE), configuration information including first information for at least one resource pool that includes a communication resource for at least one of transmission of a PRS by the UE to, or reception of a PRS by the UE from, at least one further UE,
wherein the first information defines at least one pattern of a time domain resource for the at least one resource pool.

### (Supplementary Note 48)

An access network node comprising:
means for transmitting, to a user equipment (UE), configuration information including first information for at least one resource pool that includes a communication resource for at least one of transmission of a PRS by the UE to, or reception of a PRS by the UE from, at least one further UE,
wherein the first information defines at least one pattern of a time domain resource for the at least one resource pool.

### REFERENCE SIGNS LIST

1 telecommunication system
3 UEs
5 radio access network (RAN) node, base station
7 core networks
9 cells
10 control plane functions (CPFs)
11 user plane functions (UPFs)

What is claimed is:

1. A method performed by a user equipment (UE), the method comprising:
transmitting a positioning reference signal (PRS) to, or receiving a PRS from, a further UE using a resource of at least one resource pool which is configured based on configuration information for the at least one resource pool for UE-to-UE communication; and
receiving downlink control information for activating or deactivating the resource of the at least one resource pool.

2. The method according to claim 1, wherein
the at least one PRS resource is not multiplexed with corresponding resources for data or control information.

3-8. (canceled)

9. The method according to claim 1, wherein
the configuration information includes frequency layer information defining a frequency layer for the PRS, and
the configuration information includes information for configuring at least one frequency domain resource for the at least one resource pool, based on the frequency layer information, to be within the frequency layer for the PRS.

10. The method according to claim 1, wherein
the configuration information includes:
bandwidth part (BWP) information defining a BWP for direct UE-to-UE communication, and
information for configuring at least one frequency domain resource for the at least one resource pool, based on the BWP information, to be at least partially within the BWP for direct UE-to-UE communication.

11. The method according to claim 10, wherein
the at least one frequency domain resource has a bandwidth that is wholly within a bandwidth of the BWP.

12. The method according to claim 10, wherein
the at least one frequency domain resource has a bandwidth that extends beyond at least one edge of the BWP in frequency, and
the configuration information includes information for configuring a measurement gap for the measurement of the PRS.

13. The method according to claim 10, wherein
the at least one frequency domain resource has a bandwidth that is wholly within a bandwidth of the BWP or has a bandwidth that extends beyond at least one edge of the BWP in frequency, based on a capability of the UE.

14. The method according to claim 1, wherein
The configuration information defines the at least one pattern of a time domain resource with a granularity of a number, n, of slots, where n is greater than or equal to 1.

15. The method according to claim 14, wherein
the configuration information defines the at least one pattern of a time domain resource with a granularity of a plurality of consecutive slots.

16-26. (canceled)

27. The method according to claim 1, wherein
the configuration information includes information for configuring a total number of resource pools,
the total number of resource pools is no greater than a maximum total number of resource pools, and
the maximum total number of resource pools depends on a capability of the UE.

28. The method according to claim 1, wherein
the PRS is respectively transmitted, or respectively received, with direct UE-to-UE control information in each time domain resource of at least a first subset of at least one time domain resource configured for the at least one resource pool.

29. The method according to claim 28, wherein
the PRS is respectively transmitted, or respectively received, without direct UE-to-UE control information in each time domain resource of at least a second subset of the time domain resources configured for the at least one resource pool.

30. The method according to claim 29, wherein
the first subset of the time domain resources occurs at regular intervals within the time domain resources configured for the at least one resource pool.

31. The method according to claim 1, wherein
the configuration information defines a pattern of a time domain resource in which time domain resources for the at least one resource pool occur at regular time intervals.

32. The method according to claim 1, wherein
the configuration information defines at least one periodicity for the at least one pattern.

33-35. (canceled)

36. The method according to claim 32, wherein
the at least one periodicity is dependent on a communication numerology configured for the UE.

37. The method according to claim 32, wherein
the at least one periodicity is selected from a set of possible periodicities.

38-46. (canceled)

47. A method performed by an access network node, the method comprising:
transmitting, to a user equipment (UE), configuration information for at least one resource pool including a resource for at least one of transmission of a positioning reference signal (PRS) by the UE to, or reception of a PRS by the UE from, a further UE, wherein
downlink control information for activating or deactivating the resource of the at least one resource pool is transmitted to the UE.

48. (canceled)

49. A user equipment (UE) comprising:
at least one memory storing instructions; and
at least one processor configured to process the instructions to:
transmit a positioning reference signal (PRS) to, or receive a PRS from, a further UE using a resource of at least one resource pool which is configured based on configuration information for the at least one resource pool for UE-to-UE communication, and
receive downlink control information for activating or deactivating the resource of the at least one resource pool.

50. An access network node comprising:
at least one memory storing instructions; and
at least one processor configured to process the instructions to:
transmit, to a user equipment (UE), configuration information for at least one resource pool including a resource for at least one of transmission of a positioning reference signal (PRS) by the UE to, or reception of a PRS by the UE from, a further UE, wherein
downlink control information for activating or deactivating the resource of the at least one resource pool is transmitted to the UE.
